(19) United States
(12) Patent Application Publication
(10) Pub. No.: US 2020/0372067 A1
(43) Pub. Date: Nov. 26, 2020

(54) INTERFACES, SYSTEMS, AND METHODS FOR RATING MEDIA CONTENT

(71) Applicant: Ad Fontes Media, Inc., Westminster, CO (US)

(72) Inventors: Vanessa Lea Otero, Westminster, CO (US); Robert Rapplean, Broomfield, CO (US); Donald Lloyd Watts, Mountain View, CO (US); Walter C. Dean, Washington, DC (US)

(21) Appl. No.: 16/880,898

(22) Filed: May 21, 2020

Related U.S. Application Data
(60) Provisional application No. 62/851,045, filed on May 21, 2019.

(51) Int. Cl. G06F 16/48; G06F 16/44; G06F 3/0484; H04L 29/08; G06F 3/0482

(52) U.S. Cl. CPC G06F 16/48; G06F 16/44; G06F 3/0482; H04L 67/02; G06F 3/04847

(57) ABSTRACT

A system for rating information source content having a graphical user interface comprising a graph with a y-axis representing information source bias and a y-axis representing information source reliability; a plurality of graphical scoring input tools, wherein: a first one of the plurality of graphical scoring input tools is parallel to and has a length that corresponds to a length of the y-axis; a second one of the plurality of graphical scoring input tools is parallel to and has a length that corresponds to a length of the x-axis. Each of the plurality of graphical scoring input tools is configured to accept scores corresponding to values represented on at least one of the y-axis or the x-axis upon a user's interaction with the graphical scoring input tools. The system is configured to record scores assigned by the user via the user's interaction in a database associated with the interface.

### CROSS-REFERENCE TO RELATED APPLICATIONS

This application claims priority to U.S. Provisional Application No. 62/851,045, filed May 21, 2019, and entitled “Interfaces, Systems, and Methods for Rating Media Content,” the entire disclosure of which is hereby incorporated by reference for all proper purposes.

The present application is related to U.S. Provisional Applications 62/592,397, filed Nov. 29, 2017 and 62/726,347, filed Sep. 3, 2018, and U.S. Non-Provisional application Ser. No. 16/204,795, filed Nov. 29, 2018, which are assigned to the assignee hereof and hereby expressly incorporated by reference herein. Portions of the specifications of the above-referenced applications are reproduced herein.

### FIELD

The present disclosure pertains to interfaces, systems, and method for rating media content. In particular, but without limitation, the disclosure relates to interfaces for capturing, calculating, and displaying ratings of media content.

### BACKGROUND

Systems and methods for rating and displaying news content have been described in co-owned and co-pending U.S. patent application Ser. No. 16/204,795, filed Nov. 29, 2018. Such methods include interfaces for individuals analyzing the news to input ratings into the described systems. A challenge that exists when conducting content analysis of news content is that there are many aspects of articles and shows that can be considered when rating them. Rubrics can comprise dozens of factors, and standards for applying each of those factors can be difficult for an analyst to remember.

Often, educators wish to teach students media literacy skills (and more specifically, news literacy skills) by having them analyze individual news articles and shows. However, most education tools and lessons for teaching such skills are cumbersome and difficult to use, which causes students to feel that thinking critically about news content is itself difficult, leading to many students giving up trying.

Further challenges exist to analyzing news content in any automated ways due to the number of different factors that need to be considered. Therefore, a need exists to address these challenges.

### SUMMARY

An aspect of the disclosure provides a system for rating information source content, the system being implemented via a computer having a processor and a memory, and further comprising a graphical user interface. The interface may comprise a graph comprising a y-axis representing information source bias and a y-axis representing information source reliability and a plurality of graphical scoring input tools. A first one of the plurality of graphical scoring input tools may be parallel to the y-axis and have a length that corresponds to a length of the y-axis. A second one of the plurality of graphical scoring input tools may be parallel to the x-axis and have a length that corresponds to a length of the x-axis. Each of the plurality of graphical scoring input tools may be configured to accept scores corresponding to values represented on at least one of the y-axis or the x-axis upon a user's interaction with one or more of the plurality of graphical scoring input tools. The system may be configured to record one or more scores assigned by the user via the user's interaction in a database associated with the interface.

### BRIEF DESCRIPTION OF THE DRAWINGS

FIG. 1 shows an exemplary graph that may be displayed on a graphical user interface of the interactive display system of the present disclosure.

FIG. 2A shows an exemplary method for implementing an aspect of the present disclosure for ranking and displaying an information source.

FIG. 2B shows an exemplary method for implementing an aspect of the present disclosure for ranking and displaying an individual article or show.

FIG. 3 shows an embodiment of an interactive display system of the present disclosure in which single information sources are searchable and viewable.

FIG. 4 shows an embodiment of an interactive display system of the present disclosure in which single information sources are searchable and viewable and may be subset into multiple components.

FIG. 5 shows an embodiment of an interactive display system of the present disclosure in which chosen subsets of information sources may be selected for viewing by a user.

FIG. 6 is a logical block diagram of components that may be used to implement aspects of the present disclosure.

FIG. 7 shows an embodiment of an interactive display system of the present disclosure in which individual articles are searchable, viewable, and selectable by a user.

FIG. 8 shows an embodiment of an interactive display system of the present disclosure in which individual article and/or show information may be displayed upon a user interaction with a graphical element of the display.

FIG. 9 shows a rubric for assigning one or more scores to elements of an individual article, which may be used in data gathering processes of the present disclosure.

FIG. 10 rubric for assigning one or more scores to elements of an individual show, which may be used in data gathering processes of the present disclosure.

FIG. 11 illustrates a method for using scoring inputs and algorithms of the present disclosure to automatically rate and graphically display individual articles or shows and information sources on an interactive display.

FIG. 12 shows an exemplary ratings interface having interactive graphical scoring input tools according to the present disclosure.

FIG. 13 shows another exemplary ratings interface with additional interactive graphical scoring input tools according to the present disclosure.

FIG. 14 shows another exemplary ratings interface displaying a pop-up instruction box having additional information for a user.

FIG. 15 shows an exemplary analyst home screen of the ratings interface system of the present disclosure.

FIG. 16 shows an exemplary ratings interface screen of the ratings interface system of the present disclosure having a content identification field and a submit button.

FIG. 17 shows an analyst progress screen of the ratings interface system of the present disclosure having a list indicating rating progress and button options to allow rerating.

FIG. 18 shows a chart score display screen for presenting rating results of the ratings interface system of the present disclosure.

FIG. 19 shows a coordinator dashboard screen of the ratings interface system of the present disclosure showing information about progress and statistics for a group of analysts.

FIG. 20 shows analyst addition screen of the ratings interface system of the present disclosure having a pop-up menu for adding new analysts.

FIG. 21 shows an article input screen of the ratings interface system of the present disclosure through which a user may add or delete articles to be rated.

FIG. 22 shows an analyst detail screen ratings interface system of the present disclosure having a sortable list for viewing scores assigned to information source content by analysts.

FIG. 23 shows a source score screen of the ratings interface system of the present disclosure having a list of overall calculated scores for information sources.

FIG. 24 is a diagram of a computer that may be used to implement one or more methods, systems, and displays of the present disclosure.

### DETAILED DESCRIPTION

The present disclosure provides systems and methods for rating multiple factors in news media stories along multiple dimensions in intuitive data collection and display platforms. An aspect of the disclosure relates to methods for measuring and evaluating factors of quality (also referred to herein as “reliability”) and bias of news media sources and stories. For the purposes of the present disclosure, “news media stories” may refer to written articles in print or on the internet, video clips on the internet or television, audio broadcasts such as those on the radio or podcasts, and combinations of the above, which are presented to readers or viewers for the purpose of providing any kind of information about current events. They may also include news, news-like information, commentary, analysis, and opinion in newer social media formats, such as Twitter threads, Facebook posts, infographics, or memes.

“News media sources,” or simply “information sources” may refer to journalism outlets, including print and online newspapers, print and online magazines, network TV broadcast stations, local TV stations, cable broadcast channels, cable broadcast individual shows, internet shows, radio stations and shows, online news sites, online news aggregators or feeds, app-based aggregators or feeds, and any other type of organizer, distributor, or publisher of news media stories. They may refer to entities as small as a lone individual broadcasting or posting news stories, or as large as international multi-media conglomerations.

Existing ways of measuring the news are often limited to measuring limited factors within news stories. Fact-checking organizations, for example, often only evaluate statements that are verifiable. However, many statements within an article or story are opinion or analysis statements and are not verifiable. This necessarily limits the scope of what fact-checking organizations can evaluate. Other ways of measuring the news is measuring characteristics of readers or viewers (i.e., the consumers) of the news, such as polling to ask what news consumers think about a particular story or source. Polled individuals may be asked what they find trustworthy, credible, or biased, for example. However, these polls do not actually measure much about the content of the news, but rather, attempt to draw conclusions about the content of news by the proxy of people's opinions of it. The most predominant current way of measuring news content is by measuring “engagement.” Tech companies have gotten extremely proficient at tracking how many page visits a site or an article gets, how much time a user spends on each page, what the user clicks on from there, what a user likes on social media, what a user comments on in social media, and so forth. Large monetary incentives exist for content producers to measure engagement with their content on a microscopic level, because if they can attract more visitors and views, they can command higher rates from advertisers. However, measuring engagement still does not do much to measure the content of the news itself. At best, it measures characteristics of a news source's viewers, much like polling.

To the extent that organizations try to measure news media stories and sources, they often do so by judging or rating partisan bias. Because it is difficult to define standards and metrics by which partisan bias can be measured, such ratings are often made through admittedly subjective assessments by the raters or are made by polling the public or a subset thereof. High levels of subjectivity can cause the public to be skeptical of ratings results, and polling subsets of the public can skew results in a number of directions.

Another way individuals and organizations have attempted to rate partisan bias is through software-enabled text analysis. The idea of text analysis software is appealing to researchers because the sheer volume of text of news sources is enormous. Social media companies, advertisers, and other organizations have recently used such software to perform “sentiment analysis” of content such as social media posts in order to identify how individuals and groups feel about particular topics, with the hopes that knowing such information can influence purchasing behavior. Some have endeavored to measure partisan bias in this way, by programming software to count certain words that could be categorized as “liberal” or “conservative.” However, such attempts to rate partisan bias have had mixed results, at best, because of the variation in context in which these words are presented. For example, if a word is used sarcastically, or in a quote by someone on the opposite side of the political spectrum from the side that uses that word, then the use of the word is not necessarily indicative of partisan bias. Often, other factors within an individual article or story are far more indicative of bias. Other approaches implement natural-language processing (NLP) to try to automatically categorize text, but the primary categorizations desired from news content analysis—categorizations of reliability and bias—are difficult to capture accurately due to existing limitations of NLP technology.

To date, most attempts to measure and rate news have been in terms of either fact-checking, or partisan bias, both of which have serious limitations as described above. However, it is not as if media research about the content of stories does not exist; journalism departments at major universities often engage in large-scale media research projects, and those can look at more specific qualities and factors of a subset of media. Valuable insights are available to readers of the publications resulting from such projects. However, those insights are only available inasmuch as one reads them, and such publications are often only read by those in academic circles, journalists, and those with a high level of sophistication about news media already.

Today, more news sources, articles, and stories are available to consumers than ever before. A significant portion of the population gets its news online, and specifically (and sometimes solely) through social media. The very news that is presented to them on such platforms in often governed by an algorithm that predicts what the user is likely to read. As people engage in political discourse on social media, they often use articles and videos from such sources to support their viewpoints. Many news consumers have trouble evaluating the reliability and credibility of the articles they read and videos and shows they watch. To the extent they want help evaluating these sources, their options are limited to the existing fact-checking services and partisanship ratings. When peers argue about whether a story is credible or biased, it is difficult for them to understand themselves why and how such a story is not credible and is biased. It is magnitudes more difficult to convince someone with whom one is having a disagreement why their source is not credible or is biased.

The present system provides methods for evaluating news media stories and sources across multiple factors and several dimensions, beyond fact-checking and conventional partisan bias ratings. The system also provides display mechanisms for conveying the results of such evaluations in simple, digital, interactive, and shareable formats accessible to anyone who uses the Internet. It is contemplated that in many embodiments, the methods of evaluating may be performed by human editors, who may score articles based on criteria described herein. Throughout the disclosure, users of the system performing content analysis of news media stories may be referred to as “analysts.”

In other embodiments, the methods of evaluating may be performed by a combination of software text analysis and human editorial review. In some embodiments, artificial intelligence machine learning software may perform the methods of evaluating. In embodiments, external data sets and analytics thereof may be used in combination with human ratings to assign ratings to articles not rated by humans. It is also contemplated that software may be used to calculate mathematical results of human and/or software evaluation, and that software will also be used to automatically display the results of the evaluation and calculation on computer graphical user interfaces.

In embodiments, methods for analyzing news media sources (also referred to herein as “information sources”) and stories may include algorithms for measuring numerous factors over two or more dimensions. These dimensions may comprise one that can be referred to as “overall reliability.” This dimension may be represented by the y-axis and may represent measures of information source reliability. For the purposes of the present disclosure, news sources of the highest “reliability” may be defined as those that provide readers with reporting about things that are important to them personally and important to their communities, their states, their countries, and their world, in a way that widely, deeply, and truthfully informs them.

Another dimension may comprise that can be referred to as “partisanship” or simply “bias.” This dimension may be represented by the x-axis and may represent specific measures of information source bias. Other dimensions may also be measured through multiple factors. These dimensions may include “influence,” “ownership,” “audience size,” “popularity,” and “topic selection,” but may include others. Ratings along of these dimensions may be presented in various kinds of displays, which will be discussed later in this disclosure.

Aspects of the disclosure for evaluating information sources and individual articles and shows may involve assigning “scores” to individual measures of quality and/or bias. Scores, as referred to herein, may comprise binary scores (e.g., yes/no), raw numerical scores on quantitative or qualitative scales, and assignments to a particular category. Ways in which sources and articles may be scores are described in detail throughout this disclosure.

One method for evaluating news media sources in the dimension of “overall quality” or “overall reliability” may comprise assigning ayes or no answer to each of the following factors:
a. Whether it exists in print
b. Whether it exists on TV, and if so, whether it existed before cable
c. Whether it exists on radio, and if so, whether it existed before satellite radio
d. Whether the source actively differentiates between opinion and reporting pieces
   Then, the method may comprise assigning numerical answers to each of the following factors:
e. Length of time established
f. Readership/Viewership
g. Number of journalists and staff
   The system of the present disclosure may comprise one or more databases, which will be described in more detail later in this disclosure. At least one of these databases may comprise numerical values, derived from recent research, for several quantitative measures indicative of news source reliability. The method may comprise retrieving these numerical values from the database for at least the following factors:
h. Percentage of news media stories that fall into each quality category of news story quality (as defined later in this disclosure)
i. Repetition of same news stories
j. Number of stories produced per day
   Additional factors may be added to this list and used to score news sources. In some embodiments, factors may be added based on user surveys or studies of factors that tend to indicate increased quality of news sources.

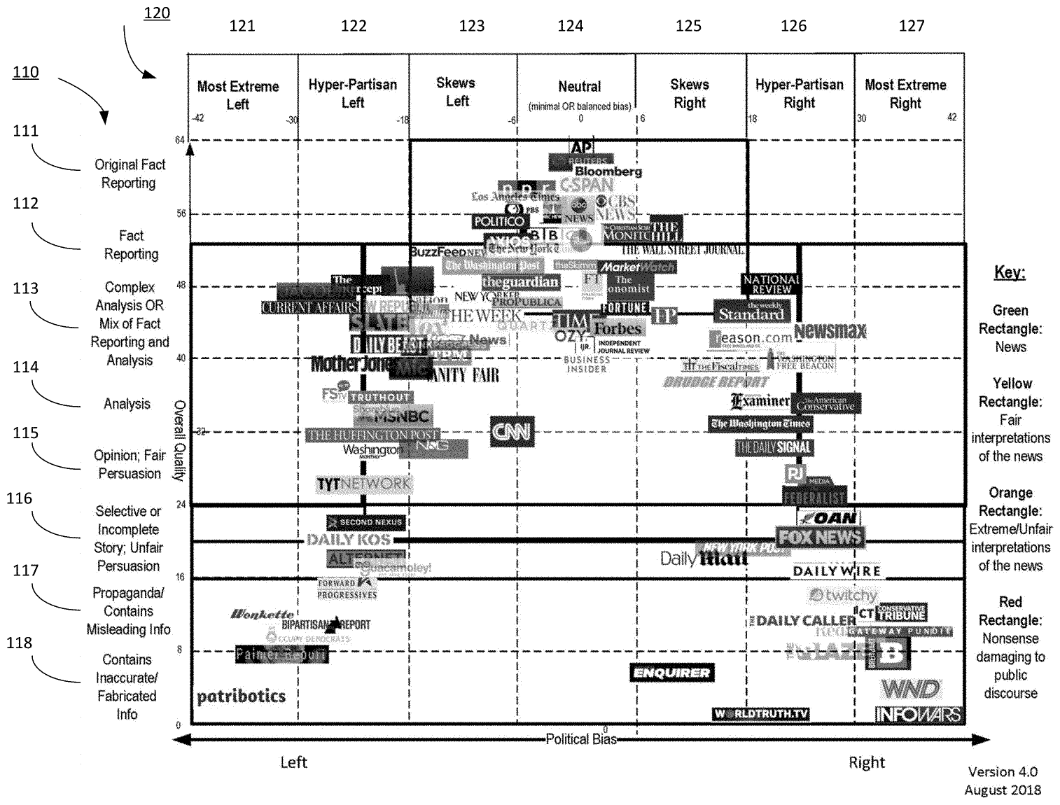

The method may then comprise calculating a position of placement on an “overall reliability” dimension of a two-dimensional visual chart. An exemplary two-dimensional chart 100 is shown in FIG. 1. As shown, a vertical axis 110 depicts an overall quality dimension which is subdivided into eight categories 111-118. The eight categories may comprise descriptions of types of news that may be found in news sources within that category. It is contemplated that more or fewer categories may comprise the vertical “overall quality” dimension, or that the descriptions may be different in other embodiments. It is also contemplated that the positions of sources in the categories may represent a strict quantitative score in some embodiments and may not represent a strict quantitative score in others. The distances between the categories may or may not represent a quantitative scale. The calculation of a position on the vertical dimension may be based on an algorithm utilizing several or all of the factors listed above. An exemplary algorithm may comprise initially assigning a source to a vertical location based on answers to factors a-d listed above. For example, a “yes” answer to “whether the source exists in print” may initially assign a source to the middle of the top two categories 111-112. “No” answers may initially assign a source to a position in the middle of the chart, between categories 115 and 116. The initial placements may or may not correspond to the descriptions of the categories but may be used as a baseline for adjusting the position of the source up or down based on other factors.

The algorithm may further comprise adjusting the vertical placement up or down based on the numerical answers to factors e-g above. In some embodiments, this step may comprise establishing a benchmark source having the highest value of all sources for that factor. For example, the oldest source for factor e (length of time established), the source largest readership or viewership number for factor f, and the source with the largest number of journalists and staff for factor g may be the benchmark sources and benchmark numbers against which other sources' vertical rankings may be adjusted. For example, if a source with the highest number of journalists has 2500 journalists, then its vertical placement may be pushed to the top of the vertical dimension, and sources with fewer journalists would be placed under it. Similarly, sources with the highest readership would be placed closer to the top. Depending on the embodiment, the order in which these factors are considered and implemented to move a source up or down may be different.

The algorithm may further comprise adjusting the vertical placements upwards or downwards based on the numerical values retrieved from the database for factors h-j. The numerical values for these factors may have the greatest weight in the final placement of the source within the actual vertical categories 111-118. In particular, factor h, the percentage of stories that fall into each quality category of news story quality (as defined later in this disclosure) may have the greatest weight in some embodiments. In some embodiments, this factor may be used to calculate an initial placement along the vertical axis, within the category 111-118 that the largest percentage of its stories falls into. In such embodiments, the other factors (e.g., a-d) may be used secondarily to move the source up or down only within that category (for example, a source that is initially placed in category 116 “selective or incomplete story; unfair persuasion,” may only be moved up within its category due to a larger number of journalists or larger readership. In other embodiments, viewership or readership may not be included as a factor on the vertical scale at all and may be represented in a different dimension altogether. For example, in some embodiments of the visual display, the chart may be interactive on a graphical user interface. A user may be able to hover over or click on a source on the chart with a mouse, and a visual indicator may expand to show a relative size of the source in relation to other sources. For example, a proportionate circle may fill the display to represent the number of viewers or readers of a source. Any of the images on the graph or chart may be referred to as graphical elements. Embodiments of these type of visualization will be discussed later in this disclosure.

As previously mentioned, the system of the disclosure may comprise one or more databases. Information in these databases may comprise numerical values, derived from recent research, for several quantitative measures indicative of partisanship. The research may be created by manual ratings by human analysts, by automated ratings by machine learning programs or other software programs, or a combination of both. The method for evaluating news media sources in the dimension of “partisanship” may comprise retrieving these numerical values from the database for at least the following factors:
a. Percentage of news media stories falling within each partisanship category (as defined later in this disclosure)
b. Reputation for a partisan point of view among other news sources (as measured by factors defined later in the disclosure)
c. Reputation for a partisan point of view among the public (as measured by surveys)
d. Party affiliation of regular journalists, contributors, and interviewees
   Additionally, the method for evaluating news media sources on the dimension of partisanship may further comprise the following factor:
e. Presence of an ideological reference or party affiliation in the title of the source
   It is contemplated that additional factors may be added to this list and used to rate news sources on the dimension of partisanship. In some embodiments, factors may be added based on user surveys or studies of factors that tend to indicate partisanship of news sources.

The method may then comprise calculating a position of placement of a source on a “partisanship” or “bias” dimension of the two-dimensional visual chart. Referring still to FIG. 1, a horizontal axis (x-axis) 120 depicts a partisanship dimension which is subdivided into seven categories 121-127. The seven categories may comprise descriptions of degrees of partisanship, with a middle category 124 representing a center and categories to the left and right representing degrees of left-leaning political bias (121-123) and right-leaning political bias (125-127). It is contemplated that more or fewer categories may comprise the horizontal “partisanship” dimension, or that the descriptions may be different in other embodiments. It is also contemplated that the positions of sources in the categories may represent a strict quantitative score in some embodiments and may not represent a strict quantitative score in others. The distances between the categories may or may not represent a quantitative scale. It is contemplated that the center category, as well as the categories to the right and left may comprise different sets of ideas over time and over geographical regions. The calculation of a position on the horizontal dimension may be based on an algorithm utilizing several or all of the factors listed above. An exemplary algorithm may comprise initially assigning a source to a horizontal location based on answers to factor a (Percentage of news media stories falling within each partisanship category), and adjusting the placement right or left based on factors b-e.

In some embodiments, the calculations of a news source's placement may be expressed as a score on a numerical scale (e.g., 80 on a scale of 1-100 vertically, and +50 on a scale of −100 to +100 horizontally). However, a numerical score does not necessarily need to be expressed in order to calculate a position on the chart. For example, a calculation may simply be expressed by placement in a particular category vertically and horizontally and adjusted up, down, right, or left based on the factors listed previously.

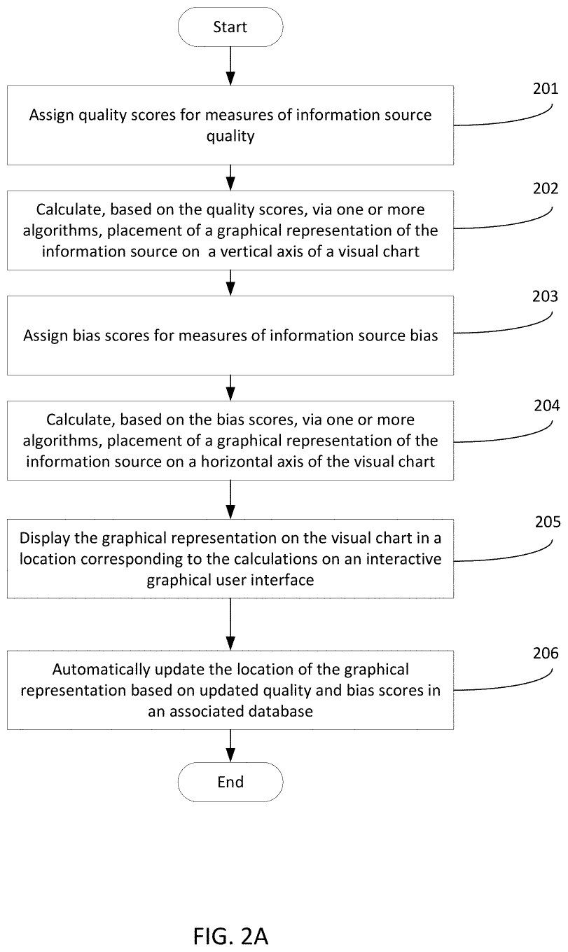

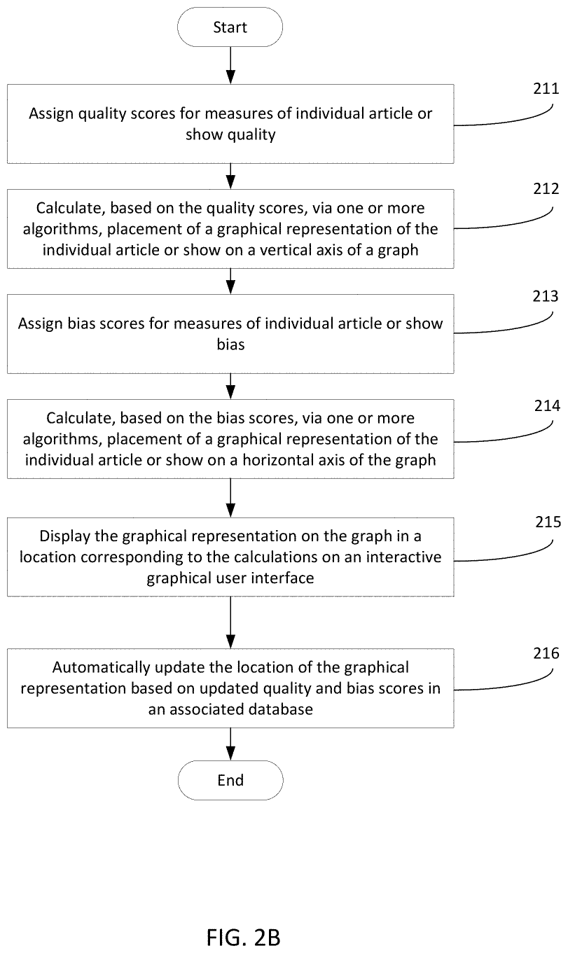

FIG. 2A and FIG. 2B show exemplary methods that may be used to implement aspects of the disclosure. FIG. 2A shows steps of a method 200 that may be implemented to rank information sources, and FIG. 2B shows steps of a method that may be implemented to rank individual articles or stories. In embodiments, the method 210 of FIG. 2B may be implemented in conjunction with the method 200 of FIG. 2A, thereby ranking individual articles or stories as a part of ranking information sources.

An aspect of the disclosure is that the results of the calculations for vertical and horizontal placement of a source may be visually displayed on an interactive chart on a graphical user interface. As shown in FIG. 1, multiple sources may be displayed on a single chart 100. In embodiments, the position of the sources on the chart may be automatically updated based on updates to the one or more databases. For example, the database may be updated frequently with new measurements of percentages of stories that fall into the vertical and horizontal categories and may be used to recalculate positions of the sources. If recalculated position values are different from previous values, then the corresponding visual ranking (i.e., vertical/horizontal placement) may be updated. It is contemplated that the database may be updated weekly, daily, hourly, or even more frequently, and that the recalculation and re-display may be updated at corresponding intervals. Historical entries into the database may be used to display how an information source's ranking has changed over time.

Other interactive features of the visual display may include, as previously discussed, an audience-size visualization display, wherein a user can hover over or click on a source to see its readership, viewership, TV ratings, or other measure of audience size. In some embodiments, this visualization may comprise a pop-up box displaying a number in text. In other embodiments, the visualization may comprise expanding a colored circle around a source name or logo. In such visualizations, it is contemplated that a benchmark size for the source with the largest audience may be set to have the largest circle when clicked or hovered over. In some displays, the image of the chart may be reduced in size (creating a “zoom out” effect) and the “audience size” circle may be expanded to overflow the edges of the chart. In some displays, the audience size circle may remain concentric with the positioning of the news source name or logo. Audience size circles for each source may be proportional in comparison to the benchmark largest circle for users to easily visualize comparative sizes between sources. A user may be able to hover over a circle and click on it to keep the circle displayed, and then hover over another circle and click it to keep it displayed simultaneously. In such displays, the other news source names or logos may remain their original size. In other displays, audience size circles may all be simultaneously displayed, with some grayed-out or translucent while in the background or not selected, and the sources of interest in brighter colors or brought to the front.

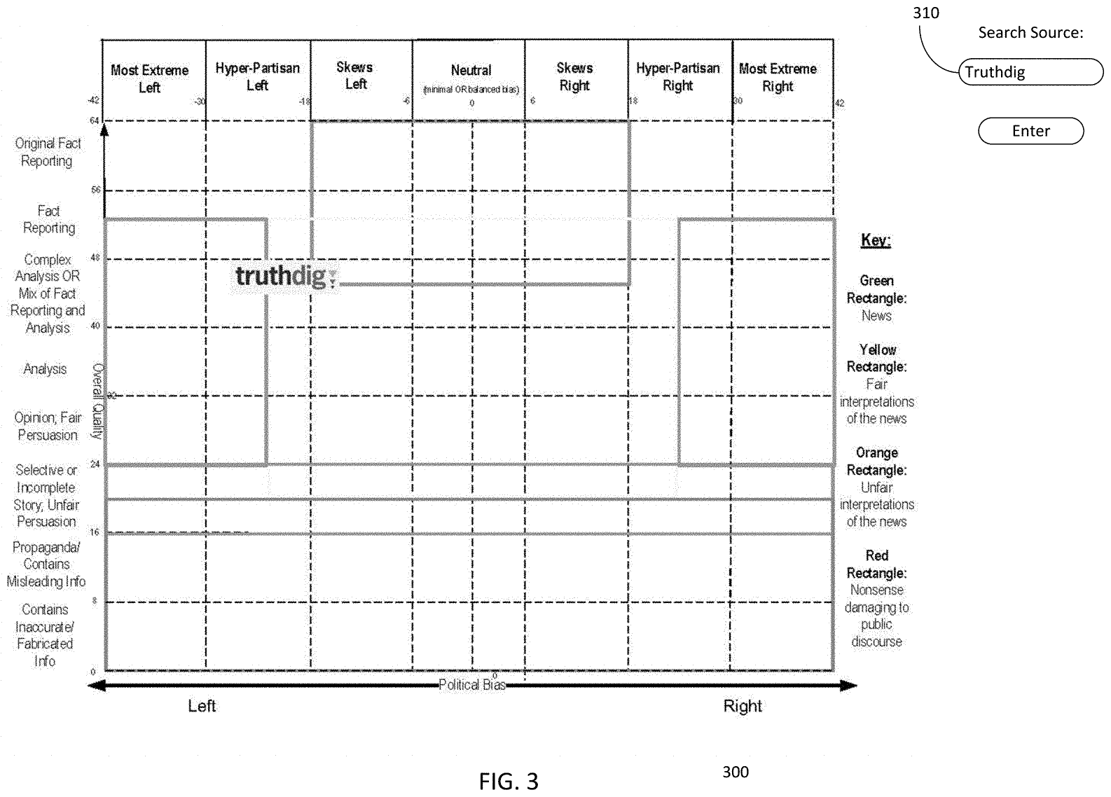

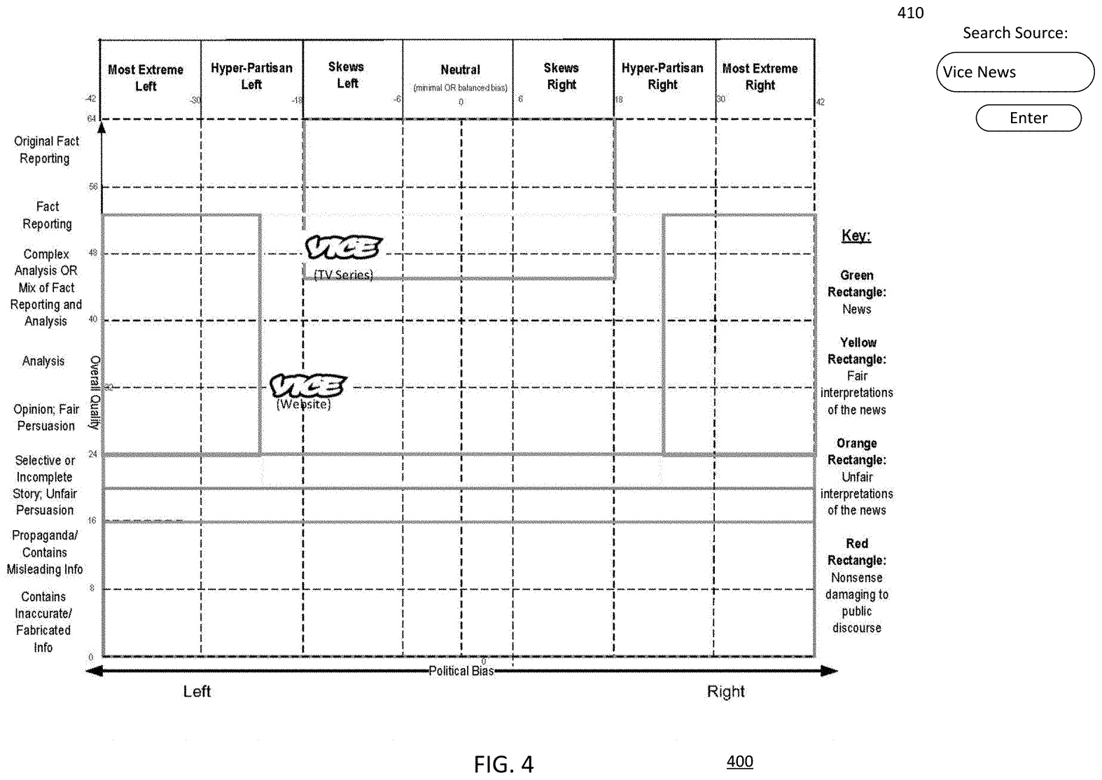

In some displays, a user may remove sources from the visual display of the chart in order to see sources of interest more easily. A user may do this in the audience size display or in any other display. A user may want to view a single source in isolation. Examples of these views are shown in FIGS. 3 and 4. FIG. 3 shows a single source that exists in an online website form, and FIG. 4 shows a single source that exists in both television and website formats. For sources that exist in multiple formats, embodiments of the system may provide rankings and displays that are distinct.

A user may arrive at the displays shown in FIGS. 3 and 4 in several ways. One way is to enter a name of a source in the search tools 310 and 410 associated with the interactive charts 300 and 400. This way may present a single source in isolation, or if the user prefers to still see where the source ranks in comparison to other sources, the single source may appear enlarged or in a bright color while other sources are grayed-out or made to appear translucent.

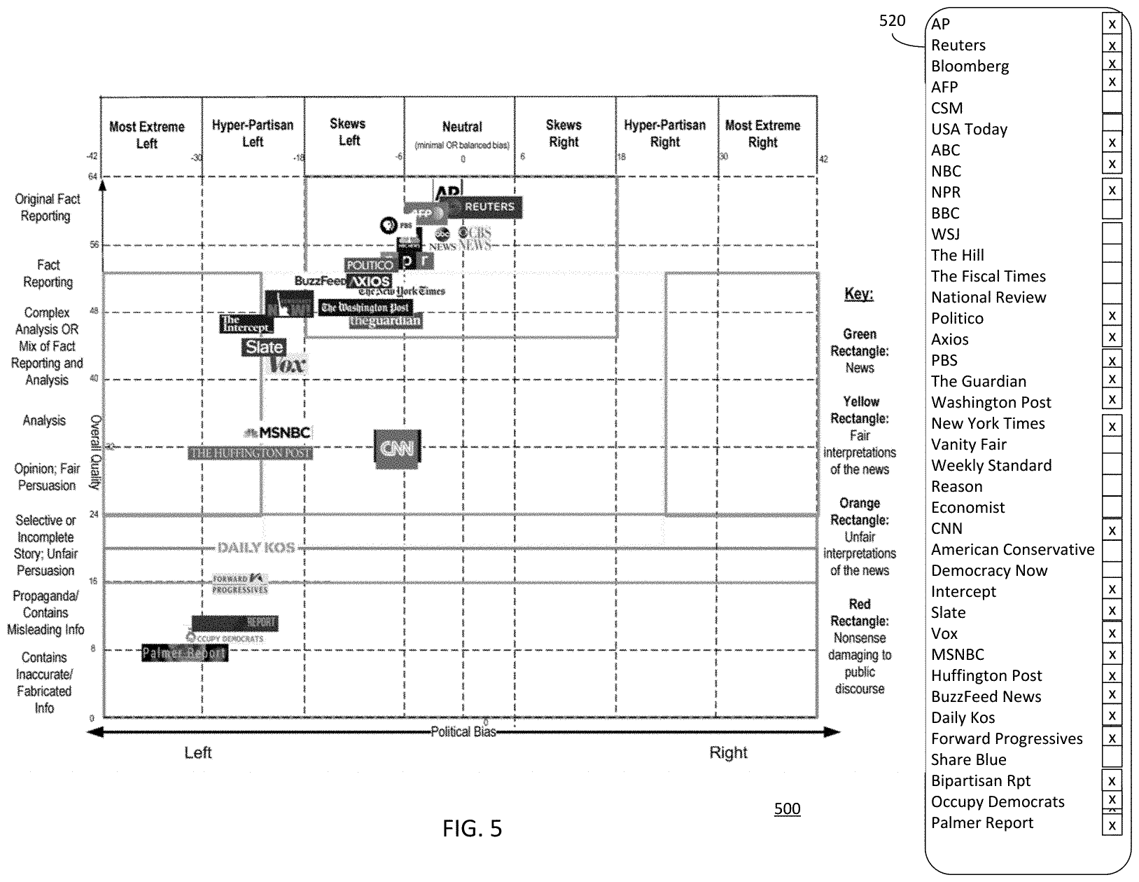

Another way a user may arrive at a display showing fewer than all the sources that are available is by selecting news sources from a list with checkboxes, as shown in FIG. 5. A user may wish to see such a display in order to get a tailored view of rankings of sources he or she relies on for news. In FIG. 5, the user may select from a selection list 520, which then displays selected news sources on the custom chart 500. A user may desire such a view to see trends in the quality and partisanship of news sources he or she often reads.

Yet other displays may be generated by how individual news media articles or stories are rated through the methods of the present disclosure. As previously discussed, one or more databases may comprise data on news sources, which may itself comprise information about overall characteristics that may be counted or otherwise measured by conventional data-gathering methods. This data on overall characteristics may include a number of stories or articles published per day, and audience size or ratings. The data on news sources may also comprise statistics calculated based on ratings of individual articles. For example, articles themselves may be ranked on a vertical dimension of quality and a horizontal dimension of partisanship, similarly to how the news sources are ranked. The information in the database may comprise total numbers of ranked articles that fall into each vertical and horizontal category. It may also comprise information on how the individual articles or stories were scored. This information may be used to calculate overall rankings or sources. In some displays, the numbers of articles that fall in particular categories may be used to calculate mean or median rankings. In others, certain articles may be weighted and use a unique formula to generate the overall source ranking. For example, a source's five most read or most shared stories may be weighted higher than any other stories. In some displays, only a source's most read, or most shared stories may be used to rank the overall source.

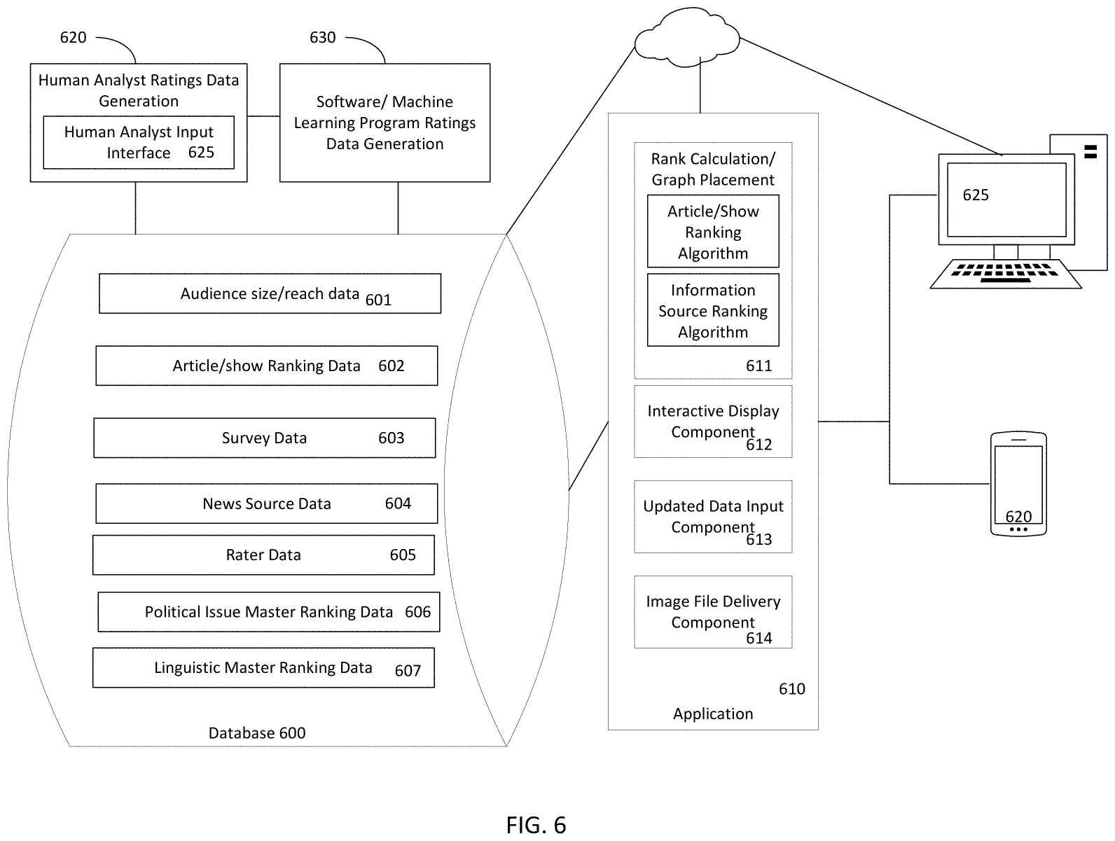

FIG. 6 is a logical block diagram illustrating a configuration of a database 600, an application 610, and computing devices 620 and 625 that may implement the system of the present disclosure. The components shown may be implemented in software, hardware, firmware, or a combination of hardware and software, and should not be construed as a hardware diagram. As shown, the database 610 may include audience size data 601, article ranking data 602, survey data 603, and news source data 604. The database may also comprise other data to be used as input to the application 610, and may be collected in any manner, such as through software or manually. The database 610 may reside on its own server in embodiments. The application 610 may use data from the database 600 as inputs to the functions of the application 610.

The application 610 may include a rank calculation component 611, an interactive display component 612, a new story input component 613, and an image file delivery component 614. The rank calculation component 611 may implement the algorithms described in this disclosure for determining where on a visual display to place a source or article. The interactive display component 612 may implement the changes, features, and functions of the graphical display on the computing devices 620 and 625. The new story input component may accept input from users on the computing devices 620 and 625 of hyperlinks or other article data that are to be submitted for evaluation by the system. The image file delivery component 614 may create portable, shareable, downloadable images, interactive files, audio, and video files for users based on their selections from the displays. The application 610 may be implemented through software-as-a-service or may be downloadable. The application 610 may be implemented on a remote application server in some embodiments, and may be used on any computing device, including smartphones.

An aspect of the present disclosure is that individual articles and stories may be scored in detail according to particular algorithms and methods. These methods may rank quality and partisanship, or other dimensions on multiple factors. The methods for ranking for quality may include individually scoring titles, ledes (i.e., introductory sections of news stories), graphics, chyrons (i.e., banners appearing at the bottom of a television news broadcast), and individual sentences of the articles or stories. In many embodiments, each sentence may be rated on a plurality of scales. The methods for ranking for partisanship may include measures of each instance of characterization of a fact, and comparisons to other stories about the same or similar topic. The methods of the present disclosure provide analysis that is systematic and relies on characteristics of the most granular units of stories. One benefits of analyzing stories in this level of detail is that it is repeatable with a high level of consistency across different human coders. Another benefit is that it can be implemented in part by software, including machine learning software in some embodiments.

The method for ranking an individual story may comprise the following steps. First, the headline (or title) may be analyzed and rated on a scale of 1-10, with 1 being the highest quality and 10 being the lowest quality, for example. The method may evaluate the headline based on one or more of the following criteria:
a. Presence of hyperbole
b. Presence of adjectives
c. Quality of grammar, spelling, punctuation, capitalization, and font size
   Then the method may comprise reading the headline and looking at a graphic or photo associated with the title (if present), and creating a statement regarding what the evaluator expects the article to be about based on reading the article and graphic or photo. Then, the evaluator may read or scan the article and determine if the content in the article matches the evaluator's expected topic based on the title to create the following factor:
d. Whether the headline matches what the evaluator expected from the content of the article
   Then, the evaluator may use the factors to rate the headline within one of the vertical categories for quality.

Then, the evaluator may individually rate the graphics or photographs associated with the article. The main criteria by which the graphic or photograph may be evaluated is fairness. The fairness metric will be described further with respect to the method for analyzing sentences of an article, but factors that may be considered to rate an article on a fairness scale may include if the photograph is unnecessarily unflattering to the subject, irrelevant to the topic of the article, or misleading as to the subject of the photograph or the article.

The method may then comprise evaluating the lede, or introductory subheading of the article. The lede may be evaluated on similar bases as individual articles, as will be described presently. For television shows, chyrons may be evaluated similarly. It is contemplated that the ratings of the headline, graphic(s), and lede or chyron may be used in addition to ratings for sentences of the article or story and used to calculate an overall ranking. It is contemplated that these elements may be weighted more heavily than the text of the article itself, because these elements are often seen and read many times more than the articles themselves are read.

The method for ranking individual sentences may comprise rating each sentence on multiple scales. These scales may include a “veracity” scale, an “expression” scale, and a “fairness” scale. Each of these scales may comprise numerical values. In embodiments, the veracity scale may comprise numerical ratings of 1-5, the numerical ratings representing the following levels of veracity:
True and Complete
Mostly True/True but Incomplete
Mixed True and False
Mostly False or Misleading
False
   In other embodiments, more or fewer levels may be implemented, in order to refine the efficiency and consistency of scoring. For example, if more or fewer categories can be used to increase the rate at which evaluators can score an entire article or increase the similarity with which different evaluators score the same article, such levels may be implemented.

The method for ranking individual sentences by quality may further comprise ranking each sentence on an “expression” scale. In embodiments, the expression scale may comprise numerical ratings of 1-5, the numerical ratings representing the following categories of expression:
(Presented as) Fact
(Presented as) Fact/Analysis (or persuasively-worded fact)
(Presented as) Analysis (well-supported by fact, reasonable)
(Presented as) Analysis/Opinion (somewhat supported by fact)
(Presented as) Opinion (unsupported by facts or by highly disputed facts)
   The categories above include whether something is “presented as” fact, analysis, etc. This expression scale focuses on the syntax and intent of the sentence, but not necessarily the absolute veracity. For example, a sentence could be presented as a fact but may be completely false or completely true. It would not be accurate to characterize a false statement, presented as fact, as an “opinion.” A sentence presented as opinion is one that provides a strong conclusion, but cannot truly be verified or debunked, because it is a conclusion based on too many individual things. Including an expression scale provides a measure for evaluating a sentence beyond conventional fact-checking methods.

Yet another step for evaluating a sentence may include scoring a sentence on another scale, which may be known as a “fairness” scale. In some embodiments, the fairness scale may comprise a numerical rating, such as 1-5 or 1-10, similar to the veracity and expression scale. In other embodiments, the fairness scale may comprise a simple fair/unfair rating. Fairness may be scored on the presence or absence of several factors, including, but not limited to:
Not relevant to present story
Not timely
Ad hominem (personal) attacks
Name-calling
Other character attacks
Quotes inserted to prove the truth of what the speaker is saying
Sentences including persuasive facts but which omit facts that would tend to prove the opposite point
Emotionally-charged adjectives
Any fact, analysis, or opinion statement that is based on false, misleading, or highly disputed premises

The method for evaluating individual articles may further include software-implemented measurements, such as total word counts and sentence counts, counts of particular words such as adjectives, counts of words in quotes, counts of hyperlinks or citations, counts of certain punctuation marks, and counts of words on customized search lists. These counts may be used in conjunction with other metrics to calculate quality scores. For example, the number of sentences with a certain rank on the veracity, expression, or fairness scales may be divided by total numbers of sentences to calculate an aspect of the overall article rating.

Once an entire article or story has been scored, the various scores may be used to calculate a position on the vertical dimension of the chart. The categories on the vertical axis may represent a range of scores within which a story may be scored to place the story in the category.

Another aspect of the method for ranking articles may comprise ranking them on a partisanship dimension. Evaluating partisanship of an article may comprise measuring certain factors that exist within the article and then accounting for context by counting and evaluating factors that exist outside of the article.

The method may first include measuring several factors within the article. First, each instance of characterization of a fact may be counted and rated on a partisanship scale from −5 to +5, with 0 being a non-partisan characterization and −5 and +5 representing the most extreme characterization. Then, the method may comprise counting words from a list of identified partisan words previously compiled. Such a list may be stored in the database and may include words associated with one political ideology or another. These words may be referred to as “partisan words.” For example, the list may comprise a list of “conservative words” such as “pro-life” or “death tax,” and a list of liberal words such as “pro-choice” and “estate tax.” The list may have partisan words added to it and deleted over time, reflecting that what comprises conservative and liberal ideas evolves over time. It is contemplated that different countries would have different partisan words on these lists. Then, the method may comprise reviewing the counted partisan words for words that would ordinarily be used to promote one side's idea, but because of the context, were actually used not to promote, or to actively refute, that side's idea. For example, if the partisan word were used sarcastically, or with a negating word, the context would indicate that the word does not promote the side's idea. In embodiments of the method, during review, the reviewer would delete instances of partisan words on the list from the count of partisan words. In other embodiments, these instances may be used in other measures of partisanship.

The method for assessing partisanship of an article may then comprise an evaluator identifying the presence of partisan topics in the article, if any. These topics may be derived from a list of partisan topics, which, like the list of partisan words, may be added to and removed from over time to reflect that what constitutes liberal and conservative ideas evolves over time. The presence of partisan ideas may be derived from words describing such topics in the article, title, graphics, or headline itself. The partisan topics list may define what a mainstream conservative position and a mainstream liberal position on the topic. An evaluator may initially rate the article based on the topics within the article in comparison to the mainstream conservative and liberal positions on the partisan topic list.

Often, the strongest indicators of partisan bias are derived from the context in which the article or story appears, and from what is not in the article or story. It is difficult to measure what is missing in an article or story, but the present disclosure provides a method for measuring these aspects in a way that is defined and repeatable. The method for measuring the partisan bias may therefore include identifying a plurality of articles from other sources (referred to herein as “lateral articles”) about a similar topic. This step may comprise identifying a minimum number of articles, such as three, five, or ten, but other minimum numbers may be used. The method may comprise identifying, among the lateral articles a “benchmark” article that has the least partisan bias. The method may also comprise identifying two “most extreme” reference articles on each partisan side. It is contemplated that rules may be implemented for what articles may be used as lateral articles, which may include a time period within which articles may be compared.

The method may then comprise identifying any major facts omitted in the article being rated that are present in the lateral articles, the omission of which impacts the partisan viewpoint of the article being rated. The method may also comprise identifying other partisan topics that the article alludes to or are present as a side issue. The presence of these topics and their comparison to the partisan topic list may also be used as a factor to rate the article along the partisanship dimension. In some embodiments, the method for measuring partisan bias may include determining where the source of the article is ranked for partisanship on the partisanship dimension of the scale. This may be a relevant factor because allusion to partisan side topics may be important when the intended audience of the article is expected to have a partisan leaning one way or another. For example, if a source is known to lean conservative, and is covering an issue about immigration, the allusion to side issues such as taxes or crime may be flashpoints for the audience and should be considered in the partisan ranking.

In some instances, evaluating lateral sources may reveal unusual circumstances that may also be used to adjust a ranking on a quality or partisanship dimension. Journalism is a field that provides widespread and immediate peer review. Journalists, in general, read and respond to articles by other journalists, and when certain articles or stories make egregious departures from journalistic norms, they are often called out immediately. When a particular article or story becomes so notorious that the article or story itself becomes news, the reasons why maybe used to adjust the ranking along one or more of the dimensions. For example, if it is revealed that the publication of a story violated an ethical rule of journalism, such as publishing a rumor without verifying it, or if a low-quality opinion piece is published in a normally high-quality publication, or if a piece omits so much context that it is tone-deaf to important current cultural issues, such circumstances may be used to adjust an overall ranking.

The above method for evaluating partisanship requires several subjective judgment calls by human evaluators but may be used over time to provide input to artificial intelligence and machine learning algorithms that can make these judgment calls with a high level of confidence. In order to validate and assess the credibility of the above methods with the public, politically balanced panels of individuals (e.g., a panel of five individuals knowledgeable about politics and news, including two self-described liberals, two self-described conservatives, and one self-described centrist) may be used to provide subjective ratings of such articles for comparison.

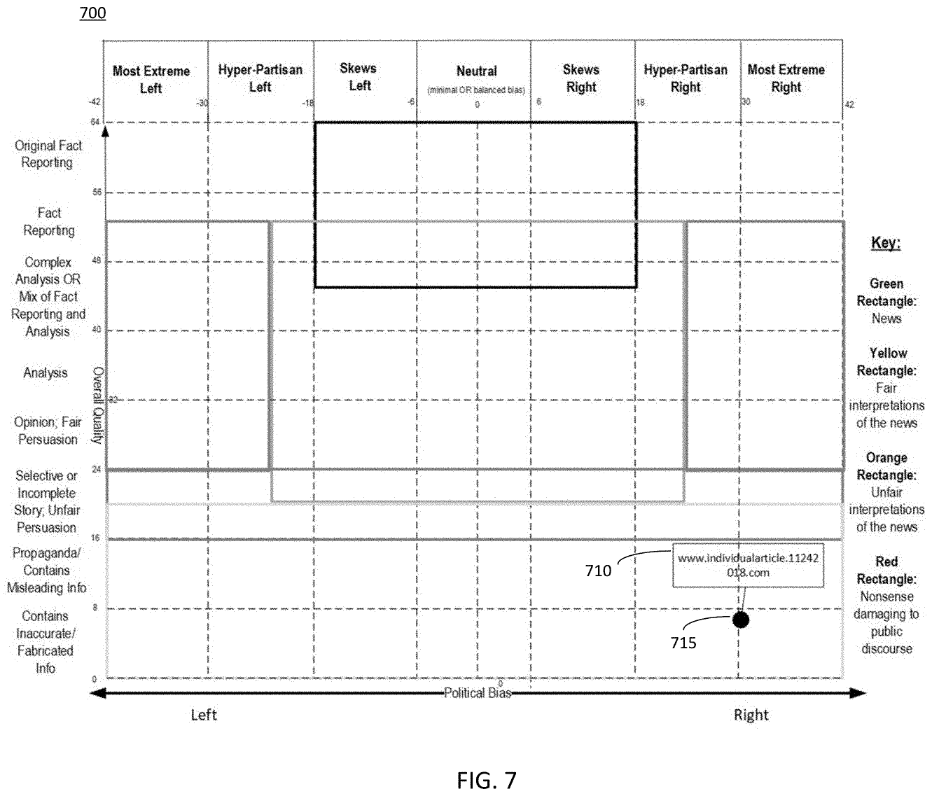

Once the partisanship of the article or story has been scored, it may be displayed on the chart as a function of its quality score and partisanship score. An individual article may be displayed on the interactive chart with a hyperlink to the article. FIG. 7 shows an exemplary display of an individual article with a hyperlink. As shown, the single article display 700 shows an individual article 710 surrounded by a color-coded border 715 (e.g., red), which may indicate that the article falls within a particular color-coded section of the chart. The hyperlink 720 may take the user to the article itself. In embodiments, when a user hovers over the article icon, a small menu may pop up, providing two options for where a user wants to go. One option may be to go to the article, and the other option may be to go to a detail page that discusses the article rating.

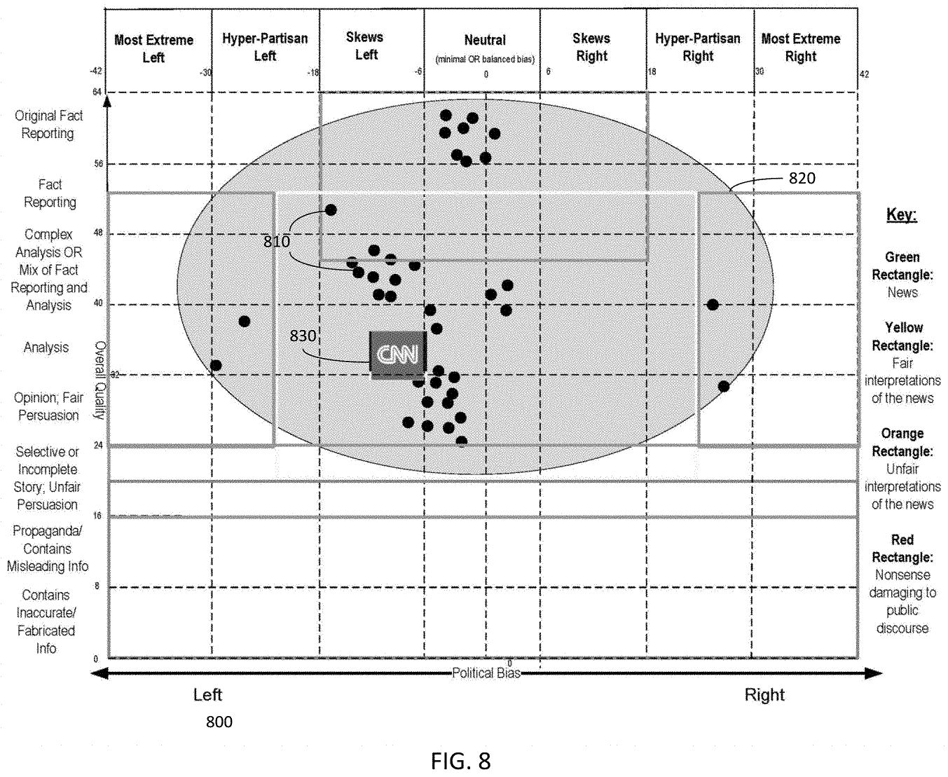

Another display may combine a view of ratings of multiple individual articles of a single source, the overall range of article quality and partisanship, and the ranking of the source, as shown in FIG. 8. This display may be referred to as a “scatter graph” view and may also be interactive. The display 800 shows several dots 810 which represent individually ranked articles, a range indicator 820, which shows the range of the individually ranked articles, and a logo of the source 830. The display 800 may be interactive and allow a user to hover over each of the dots 810, which may show more information about the article, such as the headline and date, as well as a pop-up menu like the one described with reference to FIG. 7.

In embodiments, one or more of the displays described herein may include a search function to allow users to find single sources and single rated articles. They may also include request input forms that allow a user to enter the name of a source or a website link to a source or an article to request new ratings on the display. In some embodiments, where an article has been previously rated or software is used to evaluate articles quickly, the new rating may appear immediately.

Another feature of the display is that a portable image file, such as a .jpg, .pdf, .png, .gif, or audio or video file may be obtained by a user. In some embodiments, the image file may be interactive. A user may request an image file of a display or part of a display that the user is currently viewing, and the file may be downloadable or shareable. It is contemplated that users may share these images, which show ratings of news sources and stories, in response to users posting certain stories on social media feeds. In some embodiments, color-coding schemes or symbols may be used to represent where a story or article would be ranked on the chart. It is contemplated that sites displaying news may have these color-coding schemes or symbols integrated with their displays to show where articles or stories would be ranked without having to leave the site. Some embodiments may utilize paid subscriptions to provide certain features described herein.

Embodiments of the disclosure may include additional methods of rating and algorithm translation. An aspect includes having a team of people with differing political views trained on the following ratings standards, and using multiple raters on particular articles to allow averaging of scores to minimize effects of bias. In embodiments, this ratings process may be automated and scaled up via machine learning forms of artificial intelligence. Part of this scaling-up automation process may include quality checking the AI results against subjective ratings by humans to ensure the scoring and algorithms produce results consistent with human judgments. For example, the same article may be subjectively rated on the chart by a panel of three humans, one who identifies as fairly right, one who identifies as fairly left, and one who identifies as centrist. These three ratings may be averaged for an overall subjective ranking, and a machine scored article would have to match that average ranking.

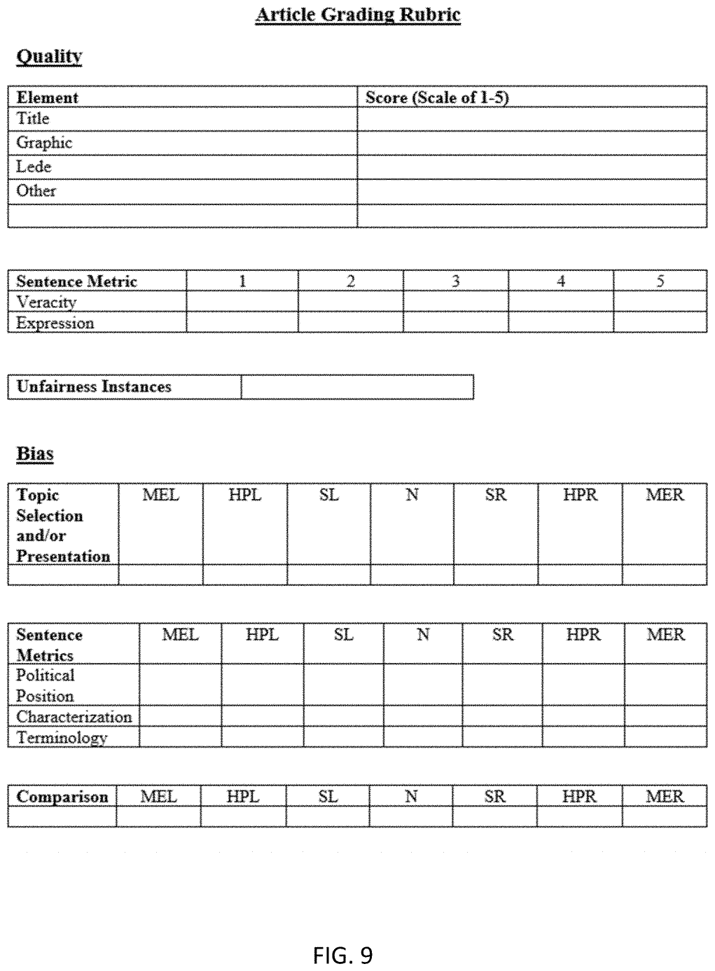

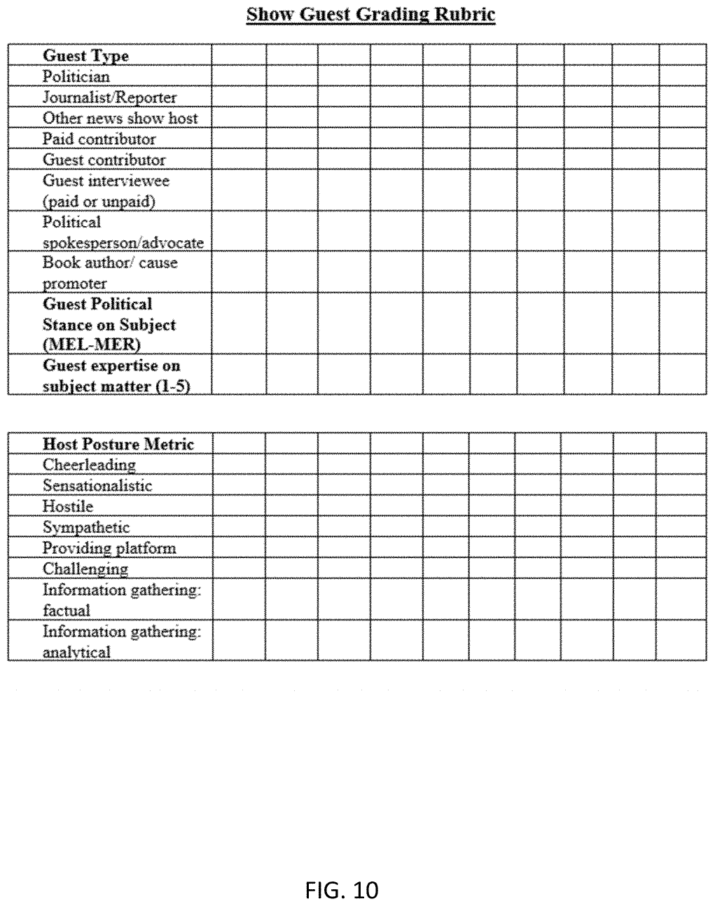

There are different, additional criteria that go into rating TV shows as compared to written articles. This disclosure first discusses the article rating methodology because the show rating methodology may use the article rating methodology as a first step and add additional show ranking criteria, which mostly deals with the quality and purpose of show guests. Exemplary rubrics for both article grading and show grading are shown in FIGS. 9 and 10, respectively.

The first of article ranking may comprise a step of rubric grading. FIG. 9 shows an article grading rubric that may be used for full rankings of articles. As shown, there are two main parts, one for a quality score and one for a bias score.

Quality rankings may comprise assigning element scores. Each element may be scored on a scale of 1-8, which corresponds to the vertical categories on the chart. Then Sentence scores may comprise rating each sentence is rated for both Veracity (1 being completely true and 5 being completely false) and Expression (1 being a fact statement and 5 being an opinion statement). Hash marks may be placed under each 1-5 category for each sentence and the total each category may be summed. Then a number of unfairness instances for the whole article may be counted.

Bias rankings may comprise rating Topic Selection and/or Presentation. The topic itself, and how it is initially presented in the headline, may be categorized in one of the seven horizontal categories on the chart (MEL=Most Extreme Left, HPL=Hyper-Partisan Left, etc.). This is one of the ways to measure bias by omission. Here, we categorize a topic in part by what it means that the source covered this topic as opposed to other available topics covered in other sources.

Bias rankings may further comprise Sentence Metrics. Not every sentence contains instances of bias related to the three types listed here, which are biases based on “political position,” “characterization,” and “terminology.” Sometimes these instances overlap. Each one throughout the article is counted.

Bias rankings may also comprise a Comparison score. The overall bias is scored in comparison to other known articles about the subject. This is a second way (and probably most important way) we measure bias by omission. Comparison is done in view of other contemporaneous stories about the same topic, and bias can be determined when we know all the possible facts that could reasonably be covered in a story.

The ranking method may then comprise Step 2: Algorithm Translation, in which the raw scores are then input into an algorithm that weights certain categories of scores and averages them, and then translates those weighted average scores into coordinates on the chart (e.g., 48, −18). The exact weighting formulas may vary, but as an example of some of the effect of the weighting decisions, consider an article that has 20 sentences, and on the Veracity scale (how true each sentence is), 14 of the sentences are 1's (completely true), 4 sentences are 3's (neither true nor false) and 2 sentences are 5's (completely false). A straight average would give this a Veracity score of 1.8 (mostly true) on this scale, but that would be a bad result because an article containing two completely, demonstrably false statements is really, really bad according to journalism standards. Therefore, any Veracity “5” scores may be weighted very heavily.

Not all algorithm weighting decisions may be so extreme, and some may be calculated as a straight average. For example, on the Expression scale, an article that has an equal number of 1's (stated very factually) and 3's (stated as analysis) would likely get an Expression score of 2 (stated factually with some analysis). There are many relationships between different raw scores on the rubric that get translated in the algorithm.

Regarding how these scores are translated onto the coordinates on the chart, a number of different raw scores may result in placements in the different categories. For example, a source that has a lot of foul language used to characterize political opponents would have high raw scores in the “unfairness instances” metric and “characterization” metric in the “Most Extreme” columns, which would result in its placement in the low bottom right or left under “Propaganda/Contains Misleading Info.” This could be the case because the content is categorized in this system as “propaganda,” even if the content were not misleading. That is, it may not have any completely false statements (no Veracity “5's”). Conversely, a different article from a different source may be placed in a similar spot on the chart because it has several Veracity “4's,” and Expression “4's,” even though it does not have high raw scores for the unfairness instances or extreme characterization metrics.

Another aspect of the present disclosure includes a Show Rating method. A first step may comprise rubric grading according to the rubric shown in FIG. 10. Grading TV shows (or video, e.g., YouTube shows) involves grading everything according to the Article Grading Rubric of FIG. 9 but also adds the Show Grading Rubric shown below.

There are several major format differences between articles and shows, the first of which is that there are many more visual elements (titles, graphics, ledes, and chyrons), each of which may be scored. The second is that a major component of most cable news shows are guest interactions, which is what the show grading rubric measures. In the system of the present disclosure, each of the Type, Political Stance, and Subject Matter Expertise of each guest, as well as the Host Posture towards each guest may be rated. In some embodiments, each of these measures may be scored by humans, and in others, human scores may be used as inputs to a machine learning program, which may then automatically score each of these elements based on previously inputted human scores. Although at first glance, many cable news shows seem to follow the same format, these guest metrics provide the greatest insight into the differences in quality and bias between shows.

The rubric in FIG. 10 helps distinguish between networks and why certain ones like Fox and MSNBC (or Fox and CNN) are not at similar places on opposite sides of the chart.

A first aspect of the show rating method includes rating Guest Type. “Guest” is a term for anyone who appears on the show who is not a host. These guests can be called any number of titles depending on the show. They can include on-site reporters, who report in a traditional style seen on network evening news programs or local new programs, but a large number of guests on cable news shows are commentators, and are called “contributors,” “analysts,” “interviewees,” etc. Many shows commonly have up to ten such guests per show. In the embodiment shown, there are ten columns on the rubric for ten guests. More or fewer may be used. Of the guest types listed (politician, journalist, paid contributor, etc.), none are necessarily indicative of quality of bias on their own. Quality and bias of guest appearances may instead be determined by the “guest type” in conjunction with each of the other metrics for each guest.

The show ratings may include a Guest Political Stance on Subject. A guest's political stance on a particular subject, if known or described during the guest appearance, is rated according to the horizontal scale (Most Extreme, Hyper-partisan, Neutral, etc.). One aspect of rating the stance of the guest within the system of the present disclosure is that ratings may be made on the particular issue at the particular time of the appearance, rather than on a stance based on a person's historical or reputational affiliation, or a broad categorization of a person's political leanings, which is a less accurate basis for rating bias of a guest appearance. That is, it is less accurate to say, “this person is liberal (or conservative)” than to say “this person took this liberal (or conservative) stance at this time.” People and their histories are complex.

For politicians, political stances on particular issues are often publicly available information via their platform or other statement of issues on their websites, and their historical/reputational stances are often the same as their stances during a particular appearance. However, it is especially important to distinguish between a guest's current stances and past affiliations, particularly during times of rapid change in politics. For example, if the current Governor of Ohio, John Kasich, appears on a show and fairly criticizes President Trump for a particular statement or action, such a stance should be rated as neutral or skews left, instead of using his party affiliation (Republican) to rate his stance as skews right. However, if he was talking about his positions on abortion or taxes, his stance would likely be rated as skews right (based on such stated right-leaning positions on Kasich's website).

The show rating may also include rating Guest Expertise on Subject Matter. This rating considers both the expertise of the guest as well as the subject matter about which the guest is asked to speak. An “expert” does not necessarily have to have particular titles, degrees, or ranks. Rather, “expertise” is defined here as the ability to provide unique insight on a topic based on experience. Although many guests have expertise and a title, degree, and/or rank, others have expertise by virtue of a particular experience instead. For example, an ordinary person who has experienced addiction to opioids may have expertise on the subject of “how opioid addiction can affect one's life.” We can refer to this type of expert as an “anecdotal” expert. However, that same person may or may not have expertise on the related subject “what are the best ways to address the opioid epidemic,” and a different kind of expert may be a physician or someone with public health policy experience. We can refer to such an expert as a “credentialed” expert.

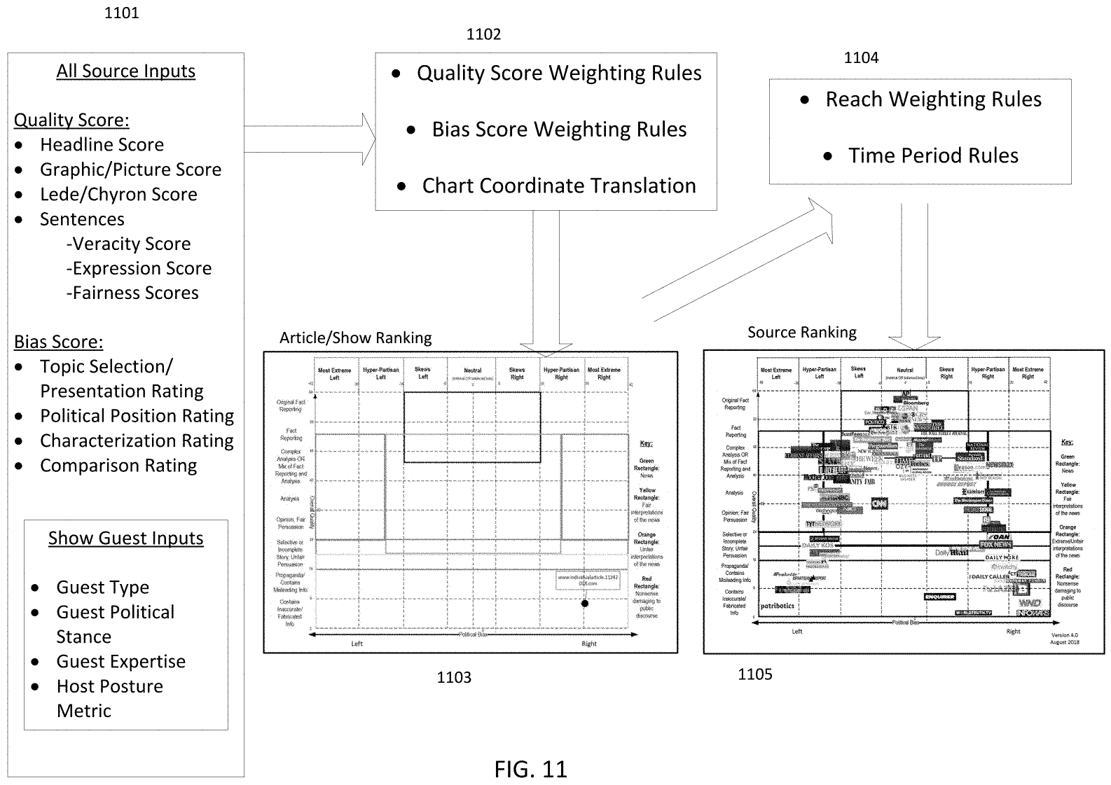

As shown in FIG. 11, Expertise may be rated on a scale of 1-5, as follows:
1: Unqualified to comment on subject matter
2: No more qualified to comment than any other avid political/news observer on political/news topic
3: Qualified on ordinarily complex topic or common experience
4. Qualified on very complex topic/Very qualified on ordinarily complex topic/Qualified on uncommon experience
5. Very qualified on very complex topic/Very qualified on very uncommon experience

As shown in FIG. 10, Host Posture Metric may also be measures. The interaction between the guest and the host also impacts the bias of the guest appearance. For example, the bias present when a host is challenging a hyper-partisan guest is quite different than the bias present when another host is sympathetic with the same hyper-partisan guest. The scale, as shown in FIG. 10, identifies several types of host postures, each of which are fairly self-explanatory. They are somewhat listed in order of “worst” to “best,” but some postures, such as “challenging,” or “sympathetic” are not necessarily good or bad, and determinations of bias depend on the context.

An embodiment of the algorithm translation method of the disclosure is shown in FIG. 11. In some embodiments, sub-charts showing rankings of individual articles, or individual shows of a particular source or network, may be displayed to users. As shown, many inputs 1101, created from human-scored or machine-scored individual element scores based on the rubrics shown in FIGS. 9 and 10, may be entered into an individual article or show rating algorithm 1102. The individual article or show rating algorithm 1102 may implement several rules, including quality score weighting rules and bias score ratings rules. An aspect of the present disclosure is the chart coordinate translation algorithm which takes raw scores from the scoring rubrics and mathematically translates them to coordinate places on the x-axis and y-axis of the interactive graph 1103.

Each of the individual article or show rankings placed on the chart 1103 may now have an associated chart coordinate position, which may itself be input into the overall information source ranking algorithm 1104, which itself has rules such as reach weighting rules and time period rules. Alternatively, or additionally, original inputs 1101 may be input into the information source ranking algorithm 1104. The rules of the information source ranking algorithm may be used to place a graphical representation of an overall information source on the interactive graphical user interface chart display. The individual article or show ranking algorithms 1102 and the overall information source ranking algorithm 1104, may be referred to as the graph placement algorithms. The graph placement algorithms 1102, 1104 may be implemented in a ranking application, which may be implemented in software, hardware, or a combination of software and hardware. The ranking application may provide and/or be implemented via an interface between one or more databases of the system and the interactive graphical user interface display.

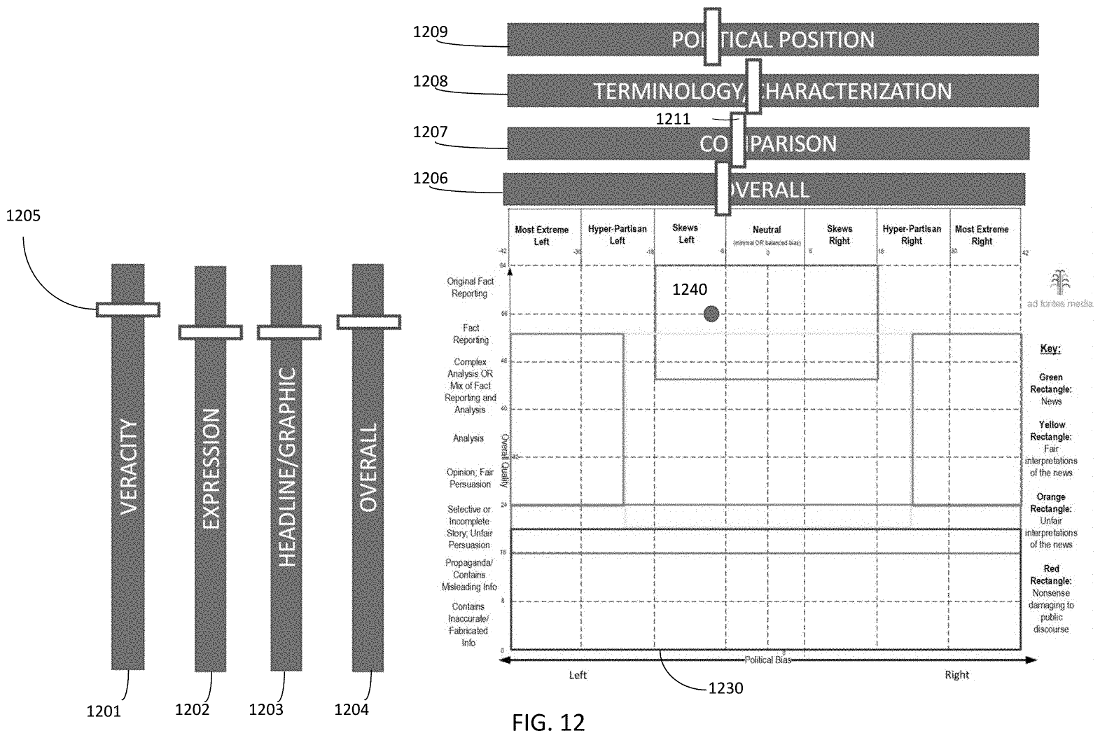

FIG. 12 shows an exemplary ratings interface according to the present disclosure. The ratings interface may have a plurality of graphical scoring input tools adjacent to a two-dimensional quality and bias chart representing factors a user may take into consideration when rating an article or show. These graphical scoring input tools may be referred to as “slider bars.” The slider bars may be graphical user interface representations of bars upon which a user can use mouse (or other input device) to adjust a visual marker (i.e., a “slider”) up or down, or left or right along the bars to indicate a score for the particular factor. In FIG. 12, the visual marker 1205 is an exemplary embodiment of a marker that may be moved up and down by a user. In embodiments, a numerical score, such as 1-5, or 1-100, may be displayed in conjunction with one or more of the sliders and/or slider bars. For example, the numerical score may be displayed on the bar, on the visual marker, or adjacent to either in embodiments.

There may be a plurality of slider bars adjacent and/or parallel to the to the y-axis for quality (also referred to herein as reliability), and a plurality of slider bars adjacent and/or parallel to the x-axis for left-right political bias. It is contemplated that the sliders for the y (vertical) axis may be on either side of the chart (i.e., on the left or on the right), and that the sliders for the x (horizontal) axis may be above or below the chart. It is contemplated that, as shown in the embodiments in the Figures, that the lengths of the slider bars may correspond to the lengths of one or both axes. The position of these sliders provides the user with several benefits. The users may be any individual person who is rating an article or show. For the purposes of this disclosure, the users may also be referred to as “analysts.” These may be professional analysts, amateur analysts, teachers, students, or news consumers. The position of these slider bars adjacent to the two-dimensional ratings chart can help users keep in mind each of the individual factors they are rating in a systematic fashion. As shown in FIG. 12, a user can consider the veracity of the overall article and assign it a place/score on a “veracity” slider bar 1201. Then the user can separately consider the expression and assign it a place/score on an “expression” slider bar 1202. Then, the user can separately consider the headline and graphic and assign it a place/score on a “headline/graphic” slider 1203. Each of these considerations are separate, but hard to keep top of mind when reading a whole article or watching a whole show. There are numerous possible advantages to having separate graphical scoring inputs when using the system of the present disclosure to teach news literacy. There are several aspects of news content that should be taken into consideration when evaluating it. A main reason many readers have trouble discerning problematic elements is because so many potential reliability factors (also referred to herein as “sub-factors”) present themselves to readers at the same time. The system of the present disclosure can help any analyst, and especially students of news literacy, focus on one element or sub-factor at a time, evaluate it closely, and move on to the next. The very practice of considering sub-factors separately can help analysts spot and precisely identify problematic elements.

Users of the interface of the present disclosure can slide the left-right x-axis sliders in upon the slider bars a similar manner to the ones parallel to the y-axis. As shown, there are slider bars for several sub-factors of bias, including a “comparison” slider bar 1207, a “terminology/characterization” slider bar 1208, and a “political position” slider bar 1209. More or fewer slider bars representing different sub-factors of bias may be implemented in other embodiments. For example, sub-factors for bias may include those described as “omission” or “language.” In the embodiment shown, the slider bars 1206-1209 are parallel to the x-axis and their lengths correspond to the length of the x-axis. The corresponding lengths provide an advantage of allowing a user to visually align a score with a particular number and/or category denoted on the x-axis. For example, an analyst could slide the slider on the “comparison” slider bar 1207 to align with the category “hyper-partisan left” and the number “−24” on the x-axis. In embodiments, a numerical score may appear on the slider 1211 itself and may change as it is moved by the user along the slider bar 1207.

It is contemplated than in embodiments, the x-axis and/or y-axis may represent other dimensions along which a piece of rated content may be cast besides quality/reliability or bias. For example, the x-axis may, in embodiments, represent a pro- to anti-dimension, such as “pro-American” to “anti-American,” or “pro-Russian” to “anti-Russian.” As another example, it may represent a “libertarian-to-authoritarian” dimension, or a “pro-democracy” to “anti-democracy” dimension. Such dimensions need not necessarily be political. For example, a bias dimension may represent a “pro-sports figure” to “anti-sports figure” dimension. In other words, the rating interface system of the present disclosure may be used to rate nearly any topic that can be cast along at least one linear dimension.

As shown, the y-axis has an “overall” slider 1204 bar positioned closest to the blank chart (which may also be referred to herein as a “graph”) 1230. In other embodiments, the “overall” slider bar 1204 near the y-axis may be labeled “reliability.” The x-axis also has an “overall” slider bar 1206 positioned closest to the chart. In other embodiments, the “overall” slider bar 1206 near the x-axis may be labeled “bias.” This overall bias slider 1206 may be manually adjusted by the user in embodiments. For example, a user may manually assign scores to each of the individual slider bars for both axes, and then, having considered each and being able to see the various scores assigned, may adjust the overall slider bars 1204, 1206 to give an overall rating for reliability and an overall one for bias. It is contemplated that the overall scores for a particular overall slider bar need not be a straight average of all the scores for sliders associated with a particular axis, because some factors may be weighted heavier for an overall score than others. For example, if an article is scored very low on the veracity slider because the article contains false or misleading information, the overall reliability score should be rated low on the overall slider, even if the scores on the expression slider and headline/graphic slider were much higher. If an article was rated to be very extreme on the political position and comparison sliders, but the terminology was mild and rated more neutral on that slider, the overall bias slider score may still be rated as quite extreme.

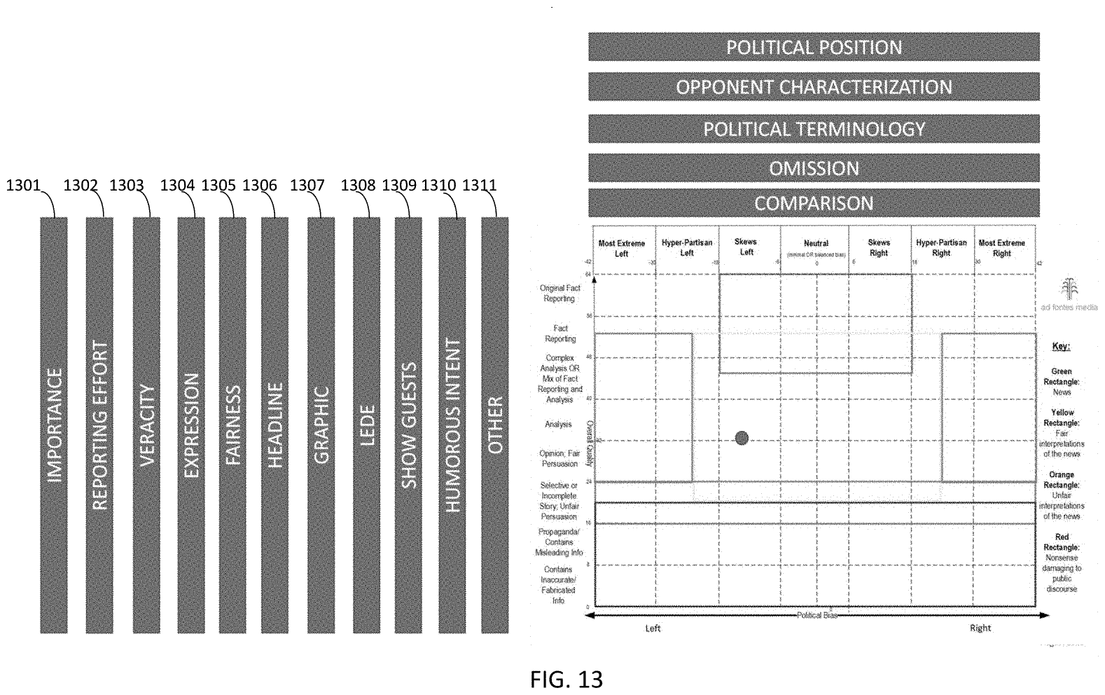

In some embodiments, though, the overall slider score may be calculated automatically by one or more algorithms. For example, the user may manually adjust each of the sliders but not the overall slider. In these embodiments, the weights of the scores for each slider may be used to automatically calculate the overall score. The overall score (whether entered manually by a user or automatically by an algorithm) may result in a visual marker such as the dot 1240 on the chart. The dot 1240 may have a numerical score associated with it, which may be displayed. In embodiments where the overall score is automatically calculated, a user may see this calculation happen automatically, with the dot moving as the user changes a rating on each of the sliders. A user may go back and adjust his or her ratings for accuracy. In other embodiments, a user may not be able to see the overall score until the slider scores are entered and may not be able to change them. These different embodiments allow administrator control over the purpose of the ratings. For example, if an administrator wanted to use ratings for the purpose of teaching, the administrator could make the overall calculation visible in real-time and could make the slider ratings adjustable after submission. If the administrator wanted to use the ratings for adjusting an algorithm, the administrator could hide the overall calculation and make the slider ratings non-adjustable after submission. In embodiments, the overall sliders 1204, 1206 may not be shown at all, as in the example shown in FIG. 13.

The individual scores for each of the sliders and the overall scores may be recorded and stored in one or more databases associated with the ratings interface. The interface may be provided as a software-as-a-service platform or may be downloadable. Ratings data may be associated with information from the individuals providing the ratings, and may include personal information such as names, education levels, and political leanings. This personal information may be anonymized in embodiments.

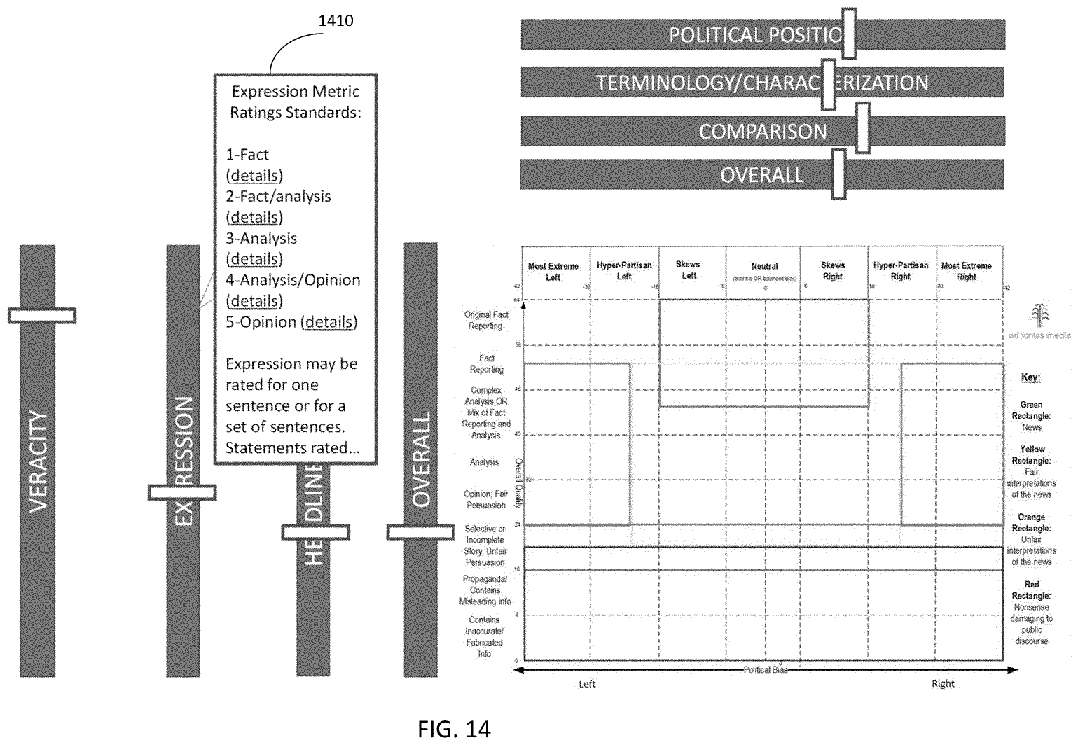

FIG. 13 shows an embodiment of the ratings interface in which more slider bars (or other graphical scoring interface tools) are associated with each axis. It is contemplated that more or fewer slider bars may be used in various embodiments. More slider bars may be used in embodiments where very experienced or professional analysts are closely analyzing many factors. As discussed previously, there are many factors that may be taken into account when rating reliability and bias of news stories. These factors may include importance 1301, reporting effort 1302, veracity 1303, expression 1304, fairness 1305, headline 1306, graphic 1307, lede 1308, show guests 1309, humorous intent 1301, and other 1311. Different names may be used for such slider bars, such as “credibility,” “authority,” “thoroughness,” “external quotes,” etc. Each of the terms on the slider bars may be associated with particular definitions, which may be made available to the analysts in various formats. One of those formats will be shown and described with reference to FIG. 14.

The x-axis sliders may also have additional sliders representing different categories. The example of FIG. 13 shows “omission” as a slider, but others may also be used. It is contemplated that in general, the more granular an article rating is desired, the more sliders may be implemented. Each of the sliders may be associated with different weights and may be used to calculate an overall score. It is contemplated that in embodiments where a human analyst manually enters an overall score, that overall score may be used to construct the algorithms for automatically calculating future overall scores. It is contemplated that for quicker ratings, and for those that are directed toward newer users, fewer sliders may be implemented. For example, a version of the interface for schools may only have one slider per axis, or three to four sliders per axis, whereas one for experienced and professional raters may have over a dozen.

FIG. 14 shows a feature in which additional information is provided to users via pop-up windows associated with the sliders. In order to achieve inter-analyst reliability, it is important to provide standard definitions for the various factors being rated. Because there are many factors to consider, it can be difficult for any user, even an experienced one, to remember the exact criteria for each factor. Therefore, the interface of the present disclosure provides pop-up windows 1410 with ratings criteria for each factor. These windows may be displayed when a user hovers over or clicks on one of the sliders. The information may be presented in a visual format as shown, or may appear as a separate window, or may be displayed in another similar manner. In embodiments, audio information may also be presented to the user. It is contemplated that the positions of the slider bars or sliders may move in relation to each other to alternately hide and appear as necessary for ease or reading.

Some graphical scoring inputs may be used to rate portions of articles and shows that comprise less than the entire article or show. For example, individual sentences may be rated via the sliders. In embodiments, individual components of articles or shows may be displayed in pop-ups or other formats next to the sliders. For example, the veracity of individual sentences may be rated by displaying sentences adjacent to the veracity slider. These may be automatically populated in a reading window via a parser that places consecutive sentences of an article in the reading window. An analyst may rate the veracity of the first sentence on the slider, submit the rating, and then the slider may reset to allow the analyst to rate the second sentence, and so on. The total ratings for each sentence may then be compiled into a weighted average veracity score for the whole article.

Again, the embodiments having more granular and detailed rating factors may be used by experienced and/or professional analysts. It is contemplated that the scores collected from each of the sliders, whether for the whole article/show or for individual sentences, may be used as training data sets for machine learning implementations of the rating system described herein.

It is contemplated that parsers may be integrated with the ratings interface and display system and used to display portions of articles and/or shows and display them alongside the corresponding sliders. For example, a headline may be populated in a window associated with the headline slider, a graphic with the graphic slider, etc. These may be populated by the parser automatically upon inputting a URL into a portion of the ratings interface system. In embodiments, a web crawler may be used to automatically input URLs into the URL input portion of the ratings interface system.

In embodiments, comment boxes implemented via text input fields may be displayed alongside the graphical scoring tools to collect written comments from analysts. These may be displayed below of next to the blank graphs and slider bars depicted in FIGS. 12-14 or may be on separate screens of the rating interface system. The comments may be stored in the database in association with the rated information source content (i.e., the article, show, or story) and its one or more recorded numerical scores. The comments may be displayed in various reporting formats in other screens of the rating interface system. In embodiments, free-form text inputs in these comment boxes from analysts may be used for analyses that compare the text inputs to the scores for the purposes of identifying patterns and automating aspects of scoring. In particular, the text inputs in the comment boxes may be used in whole or in part to train machine learning models for scoring information source content.

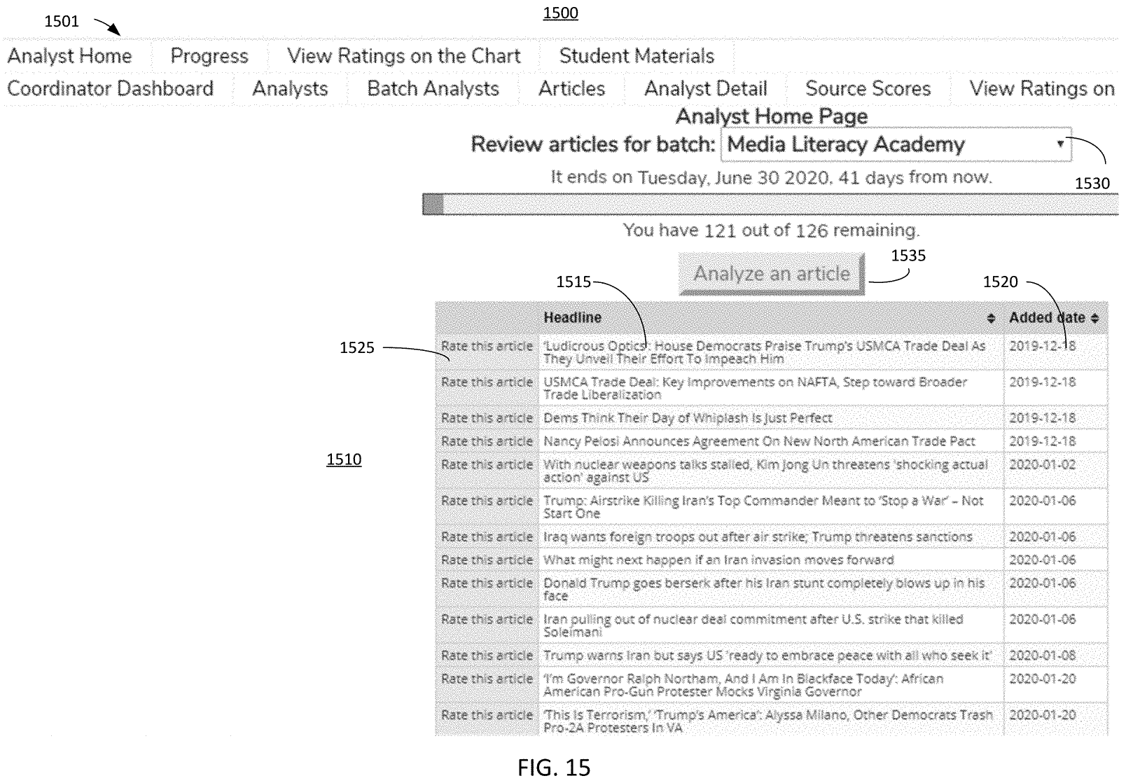

Turning now to FIG. 15, shown is an exemplary screen of the ratings interface system of the present disclosure. The exemplary screen has a menu 1500 showing available functions for analysts and coordinators, each of which will be described in detail throughout this disclosure. A first menu item is an “Analyst Home” tab 1501, which may display a list 1510 of a plurality of articles or other types of information source content. As shown, the articles in the list 1510 are identified by a headline 1515 and a date added 1520. Other types of information source content that may be identified in similar lists may include TV shows, podcasts, social media posts, images, radio shows, or any other type of news or news-like content.

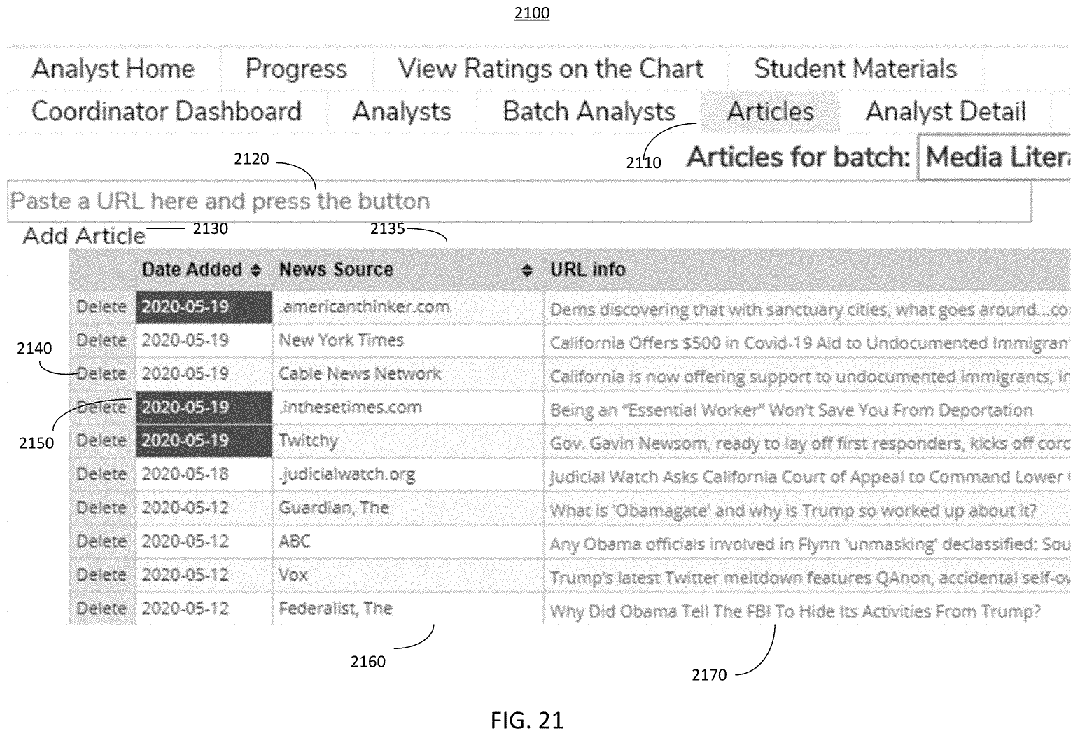

It is contemplated that each type of information source content may be identified by a piece of identifying information that facilitates an analyst's ability to recognize the nature of the content he or she is about to rate. For example, a piece of identifying information for a TV show, radio show, or podcast may be a name of the program and its air date and/or time. A piece of identifying information for a social media post or image may be a free-form text description and/or a thumbnail image. In the embodiment shown in FIG. 15, part of the identifying information for the article (i.e., the headline) may be derived from parsing a web page whose URL has been entered into the ratings interface system in another screen of the interface system (e.g., the screen shown in FIG. 21). In other embodiments, the identifying information may be derived from any form of manual or automatic entry.

The analyst home screen depicted in FIG. 15 also includes a drop-down menu 1530 indicating a name of a “batch.” For the purposes of the present disclosure, the term “batch” may refer to groups of information source content to rate, such as a group of articles. Batches may be grouped according to any criteria, such as date, subject matter, group of analysts to which it may be assigned, type of content (e.g., show, podcast, etc.) rating method (e.g., simple, complex) and the like. The batch listed in the drop-down menu 1530 is entitled “Media Literacy Academy,” an exemplary name of an educational institution, which may indicate that all articles listed in the “Media Literacy Academy” batch are associated with the educational institution.

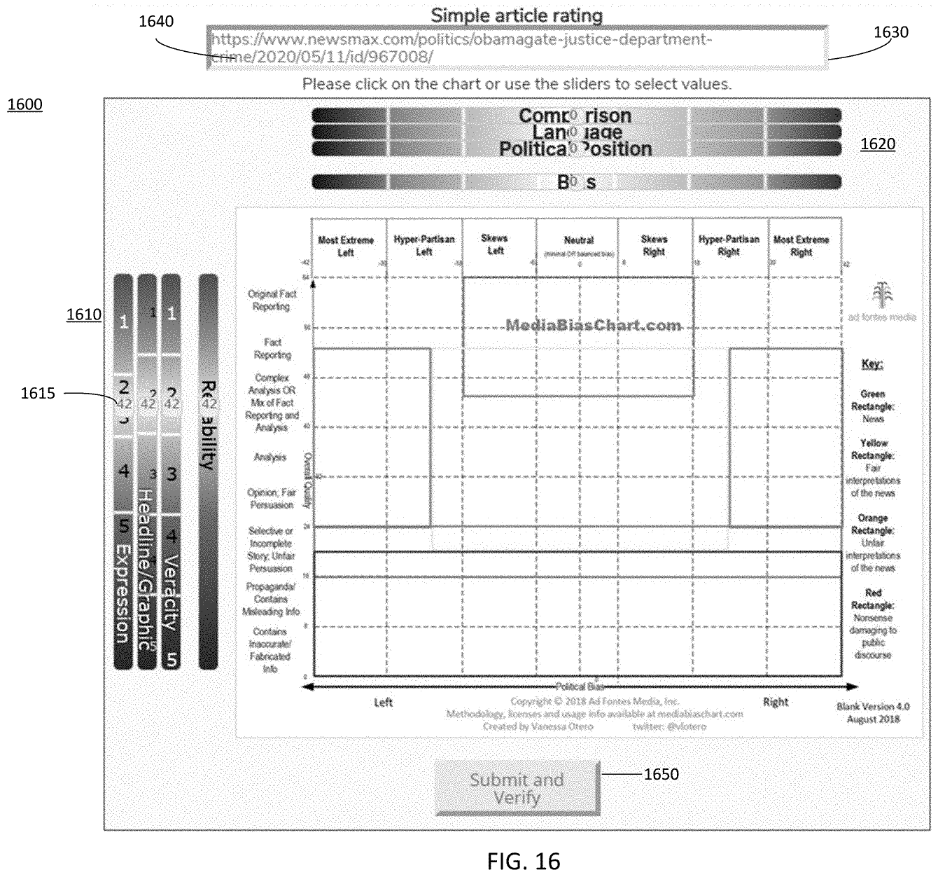

The list 1510 shown in FIG. 15 may also include buttons 1525 which allow a user to select an associated article to rate. The buttons 1525 may be configured to bring a user to another screen of the ratings interface system, such as the graphical ratings interface shown in FIG. 16, and/or present the article (or other news content/information source content) selected to be rated. Alternatively, a user may click on a random assignment button 1535 configured to present a random available piece of news content to the user for rating.

FIG. 16 shows another exemplary screen of the ratings interface system—a graphical ratings interface 1600, which has slider bars 1610, 1620 configured to operate as previously described with reference to FIGS. 12-14. In the embodiment shown, numerical scores appear on the sliders 1615. The slider bars themselves are additionally marked with numerical indicators. The graphical ratings interface 1600 also comprises a content identification and presentation field 1630. In the embodiment shown, the information source content is identified by a URL 1640, which is hyperlinked. As a result, the content identification (the URL) facilitates the presentation. Clicking on the URL 1640 will present the user with the article, and in embodiments the article may be configured to pop out in a new tab or new window of the user's browser.

It is contemplated that for other types of information source content, such as TV shows, radio shows, podcasts, and social media posts, which may or may not be associated with a URL, different pieces of identifying information may be presented to an analyst in a different type of content identification field. For example, a content identification field may list a TV show name, air date, and time; a podcast may list a podcast name, episode title, and release date. An image or screenshot of a social media post may include a free-form description and/or a thumbnail image.

For such pieces of content, a user may have to access the content outside of the ratings interface system to view or listen to it, but may still rate the content and have a score associated with the identifying information about the content recorded within the ratings interface system. In other embodiments, actual content files may be stored in one or more associated databases of the ratings interface system. In embodiments, such content may be presented in a content presentation field of the ratings interface system. Such a content presentation field may be different from a content identification field and may be on a separate screen of the ratings interface. It is contemplated that news content may be stored or archived in databases associated with the ratings interface system. Such news content may include recordings of TV and radio programs, podcasts, images, text files, PDF files, transcripts, or any other type of content file.

Once an analyst assesses the presented piece of news content and uses the graphical scoring input tools 1610, 1620 to assign scores to it, the analyst may click on a submit button 1650. The submit button 1650 may optionally present a verification screen with one or more additional buttons to allow the analyst to confirm their score, but in any event, the clicking of the submit button 1650 may cause the ratings interface system to record the analyst's score for the news content in a ratings database of the ratings interface system.

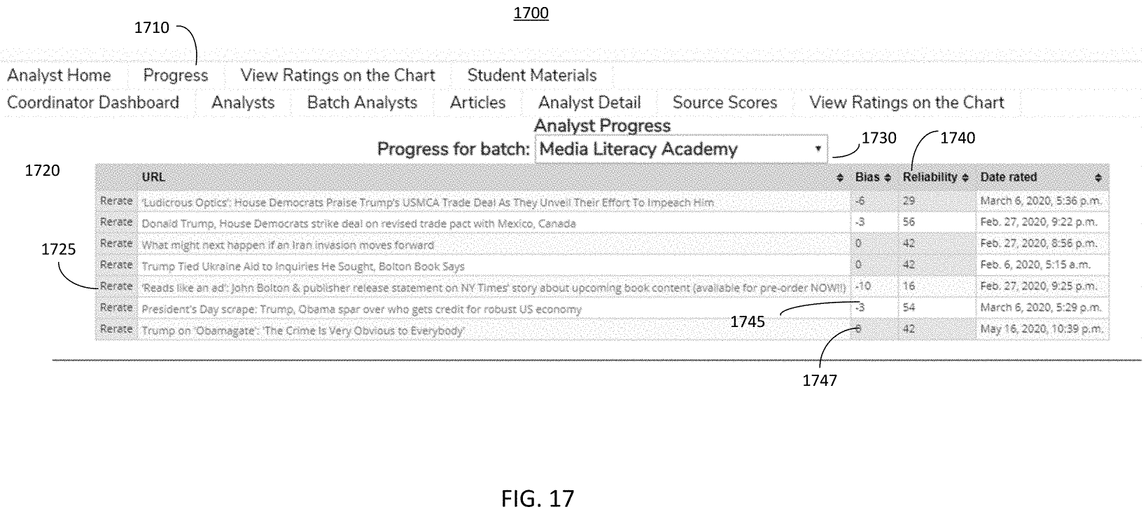

FIG. 17 shows an exemplary screen of the ratings interface system showing an analyst progress page 1700, which may appear upon the analysts' selection of the progress menu tab 1710. The analyst progress page 1700 may include a drop-down menu 1730, which may allow an analyst to choose between multiple batches to which the analysts is assigned, if available. The analyst progress page 1700 may also include a list of articles 1720 by title, which in other embodiments may comprise a list of other information source content identifiers. As shown, each of the articles in the list 1720 is displayed next to a “rerate” button 1725, which is configured to allow an analyst to rate the associated article again. In embodiments, the rerate button 1725 may be labeled with a similar term such as “rate again.” The list of articles 1720 as shown also displays scores 1740 associated with a particular article so an analyst can see if an existing score 1745 or a default score 1747 is associated at the time of viewing the list. A default score 1745 may be a numerical score (e.g., 0, 42) associated with sliders in their default starting positions, which may indicate that the analyst has not rated the article yet. In embodiments, any scores that are not finalized or which are problematic for some reason may be highlighted to draw the analyst's attention to it. For example, default scores may be highlighted, scores that have been entered and not verified or submitted may be highlighted, and/or scores which fall outside a certain threshold of other analyst's scores may be highlighted.

An advantage of allowing an analyst to rerate an article is that reading and rating multiple articles about a similar news topic often exposes an analyst to different facts, conclusions, analyses, opinions, and ranges of biases, and exposure to these different elements may cause an analyst to assess a previously rated factor differently. For example, if an analyst reads an article and initially believes a stated fact in it is true, but later reads another article and discovers that the stated fact in the first article is true, the analyst may wish to adjust the veracity and/or reliability score for that article. As another example, if the analyst reads a first article and believes it to be among the most biased articles that could possibly exist on a topic, but later reads a second article that is even more biased, the analyst may wish to change the comparison score for the first article. In embodiments, the new rating may either be recorded over, or in addition to, the initial rating.

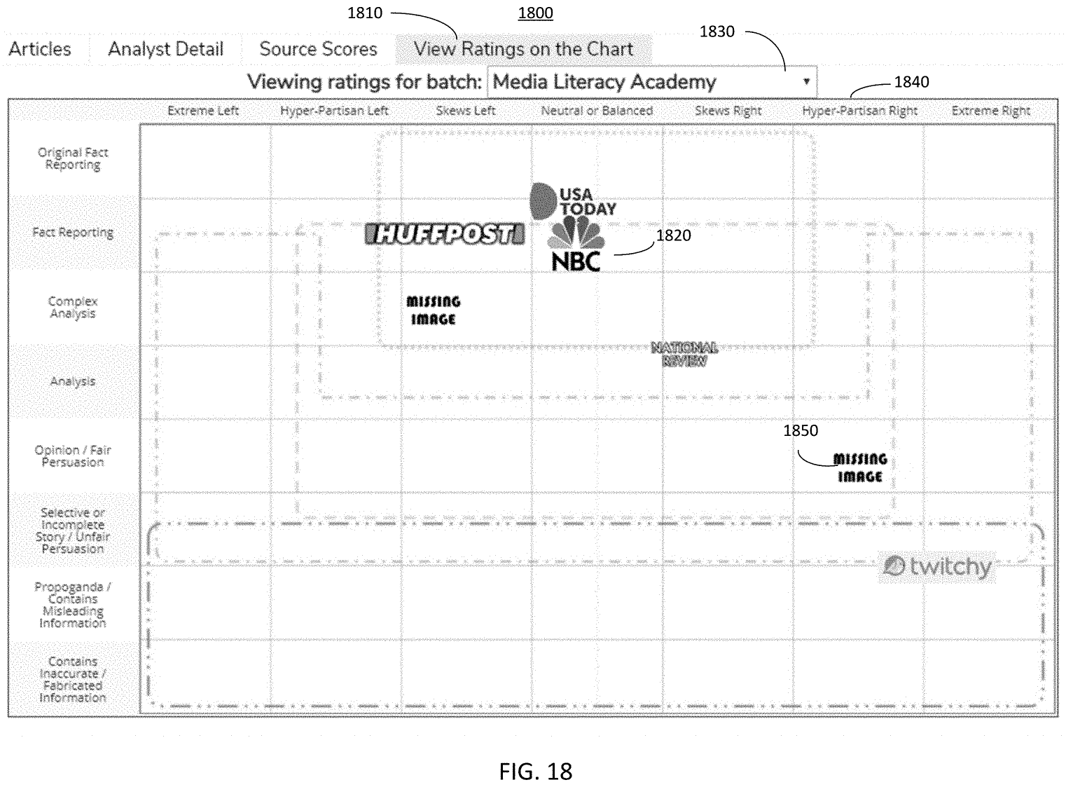

Turning to FIG. 18, shown is a two-dimensional chart score display screen 1800 of the rating interface system, which may be accessible to one or more users of the system by selecting a “view ratings’ menu option. The chart score display screen may comprise a blank chart 1840 having the same categories as the blank chart the scoring interface. In embodiments, there may be a plurality of chart score display screens 1800 throughout the rating interface having slightly different display functions. For example, a first chart score display screen for an individual analyst may display scores assigned solely by that individual analyst. A second chart score display screen may display an average (or algorithmically weighted average) of scores from a plurality of analysts under the direction of a “coordinator” user. Roles and functions of a coordinator will be described later in this disclosure. The average or weighted average scores for individual content pieces may be represented by a logo 1820 for a particular information source, as shown in FIG. 18.

An advantage of the chart score display screens is that they may quickly and easily convey to a user how a piece of news source content and/or the overall information source was scored. Analysts can compare and contrast their own scores at a glance to those of their peers, to those of professional analysts, or to the average scores given by a set of analysts. Coordinators may view the overall ratings of groups of analysts at a glance. The chart score display screen may include a drop-down menu 1830 which allows the user to select scores to view from any available batch of articles. Upon choosing a particular batch, the logos or other visual representations on the chart may automatically update to reflect the selected batch's scores. It is contemplated that different visual representations may be used in place of a logo. For example, a “missing image” icon 1850 may be used in the event a logo is not stored in the database associated with the ratings interface system. Other representations, such as dots or shapes, may be used to represent individual content piece ratings or whole information source ratings averages or weighted averages.

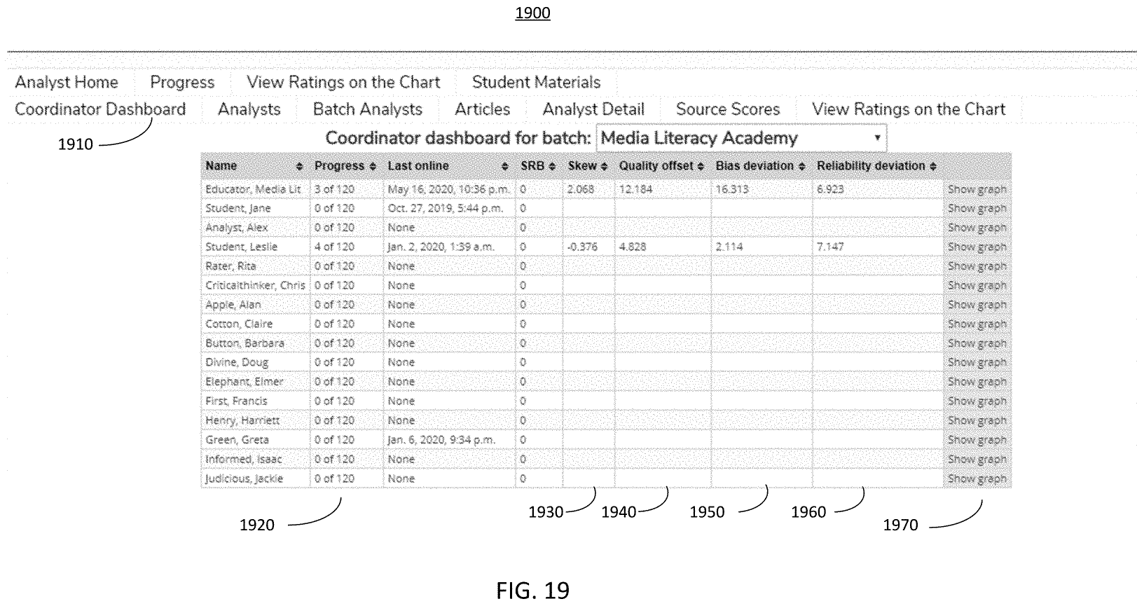

FIG. 19 shows a coordinator dashboard screen 1900 of the ratings interface system. A coordinator user, as briefly referenced above, may be a user having permissions and functions to facilitate the use of the ratings interface system by multiple analysts. For example, a coordinator may be a teacher, a librarian, or a leader of a ratings project. Coordinator functions may include the ability to add analysts, add articles, assign analysts to batches, view analyst progress and ratings, view overall source scores created by groups of analysts, and more. These functions will be described with reference to FIGS. 19-23.

In FIG. 19, the coordinator dashboard screen 1900, which may be accessed by the coordinator dashboard menu tab 1910, a coordinator may view several pieces of information associated with each analyst in the coordinator's group. The coordinator may be able to view analyst progress in a progress column 1920, showing how many articles an analyst has rated out of a set of assigned articles. The coordinator may be able to view several statistics about analyst scores such as skew 1930, quality offset 1940, bias deviation, 1950, and reliability deviation 1960. These are exemplary statistics and others may be automatically calculated and displayed in other embodiments. In the embodiment shown, the system automatically calculates skew and offset, which are measures of the tendency of particular analysts to deviate from a mean of bias scores in view of reliability scores and vice versa. It also calculates bias deviation 1950 and reliability deviation 1970, which are average differences of the particular analyst's scores for bias and deviation from the mean of each for the whole analyst group. In the embodiment shown, the coordinator dashboard screen 1900 also includes a “show graph” button that provides a visual display of the automatically calculated statistics.

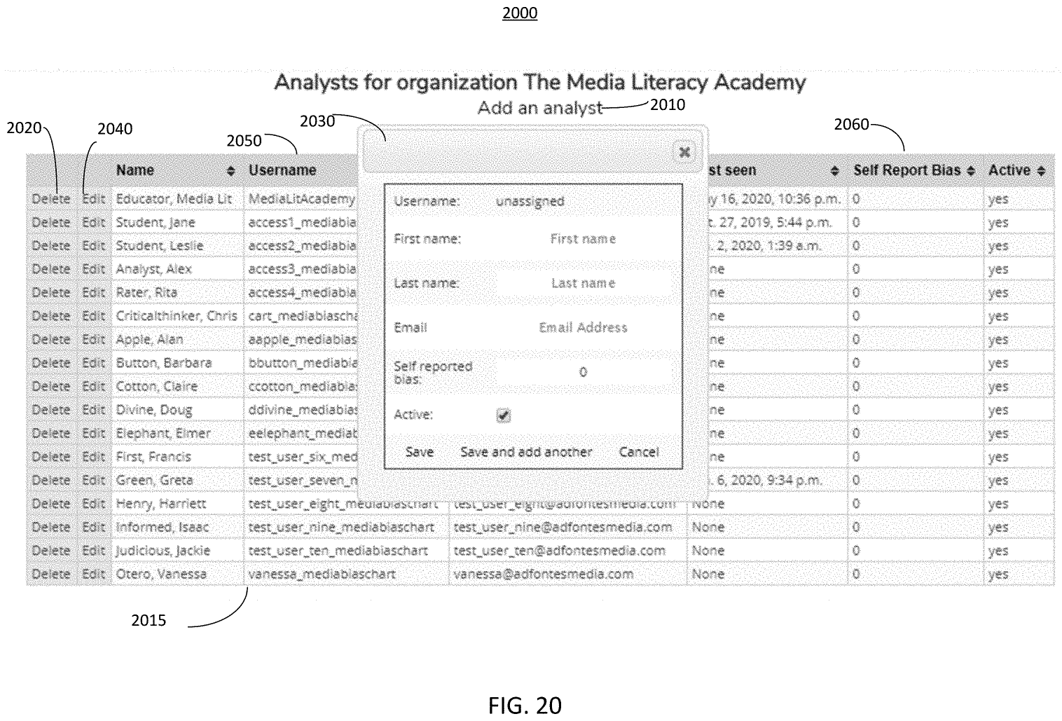

FIG. 20 shows an analyst addition screen 2000 of the ratings interface system. The analyst addition screen 2000 comprises a list of added analysts 2015 and an “add an analyst” button 2010, which pops out an analyst addition window 2030. The analyst addition window 2030, as shown, comprises input fields to allow the entry of identifying information for individual analysts, including name, email address, and “self-reported bias.” Self-reported bias may optionally be entered as a numerical value associated with a political affiliation of the analyst and may be used to calculate other statistics. For example, it may be desirable in the course of a set of news source ratings to ensure a balance of left and right-leaning analysts, or left, right, and center-leaning analysts. Trends in the bias of the scoring of each of the analysts may appear over time, and overall scoring may optionally be adjusted to account for each analyst's calculated bias.

The ratings interface system may automatically generate a username for any analyst entered. The list of analysts 2015 may include functions for administration of the analyst list, such as the ability to delete or edit analysts via a delete button 2020 and an edit button 2040. Usernames may be displayed in a username column 2050, and self-reported bias may be displayed in a self-report bias column 2060. In embodiments, analysts may be added in bulk from a spreadsheet such as a CSV (comma delimited) file.

Coordinators may also have the ability to add articles (or other pieces of news content) to be rated by analysts. FIG. 21 shows an article input screen 2100 of the ratings interface system, which may be accessed via an articles menu tab 2110. The article input screen 2100 as shown comprises an article input field 2120 configured to accept identifying information about a piece of information source content—in this case a URL. A coordinator may enter any URL and press an “add an article” button 2130, which stores the URL in a database associated with the ratings interface system and adds the URL to the article list 2135. In other embodiments, various different fields may exist for entering identifying information about a piece of information source content, such as text input fields for names and air dates of TV or radio shows, for example. In such embodiments, the list 2135 may appear in a different format, with different identifying information in place of the URL info column 2170.

Upon entering a URL in the article input field 2120, the ratings interface system may implement a parser to identify portions of the URL and article, such as the name of the information source and the title of the article. These may then be displayed in the news source column 2160 and the URL info column 2170. The article input screen 2100 as shown allows a coordinator to delete articles via a delete button 2140. It is contemplated that deleting an article from such a list may not delete the article from the database, especially in instances where rating scores from some analysts are already associated with the particular article. In various screens of the ratings interface system, portions of a listed article may be highlighted as shown in the highlighted row 2150. Such highlights may be used to inform a coordinator that certain thresholds of numbers of ratings had not been collected from analysts yet. Such threshold numbers may be set by an administrator for various purposes, such as ensuring that a minimum number of ratings falling withing a particular range of each other had been detected.

In embodiments, articles or other content may be automatically added to an article input screen and/or directly to a database via an API, web page form, browser extension, or some combination thereof. For example, news consumers may wish to request that particular news content be rated using the systems and methodologies of the present disclosure or report news content that they perceive as problematic in terms of reliability and/or bias. External text fields implemented on web forms or on browser extensions may be used to route such news content identifying information (such as URLs) to the database of the present system via an API.

There are several advantages to enabling coordinators to add and delete articles (or other information source content) from an information source content input screen. In certain implementations, administrator users or coordinators may add sets of selected articles to coordinators' and analysts' batches as part of an educational program. However, certain coordinators may be teachers who wish to implement different objectives and analyze different sets of articles. An educator may wish to cover different political topics or certain grade-level appropriate content. The ability to add and delete any content provides educators maximum flexibility.

Further, the ability to add any information source content that may be rated along one or more dimensions allows the content analysis methodology of the present disclosure to be implemented across languages and geographical regions and across all mediums of content. Since there is seemingly infinite news and news-like content, the ability to rate any or all of it according to a standardized methodology can provide important rating data that can be used in numerous applications. News content rating data may beneficially be used by educators, researchers, news publishers, social media platforms, advertisers, and of course, news consumers.

In embodiments, coordinators or administrative users may have the ability to create separate groupings of articles into batches and may have the ability to merge or delete entire batches from other batches. Batches of articles may be grouped according to any criteria, such as date, topic, or organization, and it is contemplated that multiple sets of analysts may desire to rate the same batches or articles as other sets of analysts.

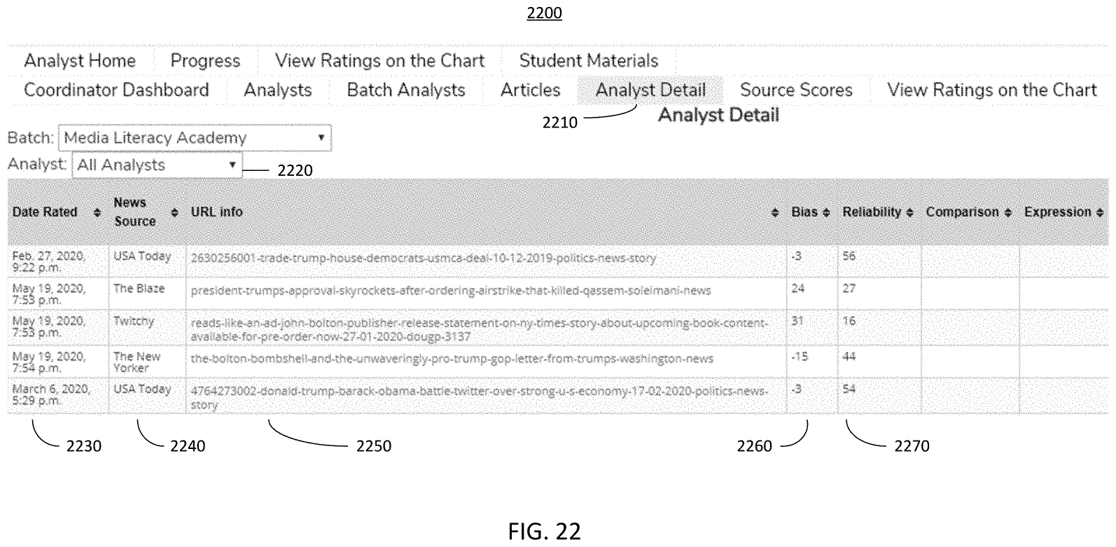

Various reporting features are available to coordinators in the ratings interface system. FIG. 22 shows an analyst detail screen 2200 of the present system, which may be accessed via an analyst detail menu 2210. The analyst detail screen 2200 as shown comprises a drop-down menu 2220 which may allow a coordinator to select all analysts to see all scores or to see individual analyst's scores by article. The analyst detail screen shows a date rated 2230, a name of the news source 2240, URL info 2250, and bias score 2260 and reliability score 2270. Other individual sub-factor scores may be shown as well. Each column is sortable, so coordinators can organize the list by news source, URL, analyst, or any other column criteria. This reporting feature beneficially allows coordinators to assess the accuracy of analysts' ratings and assist in grading.

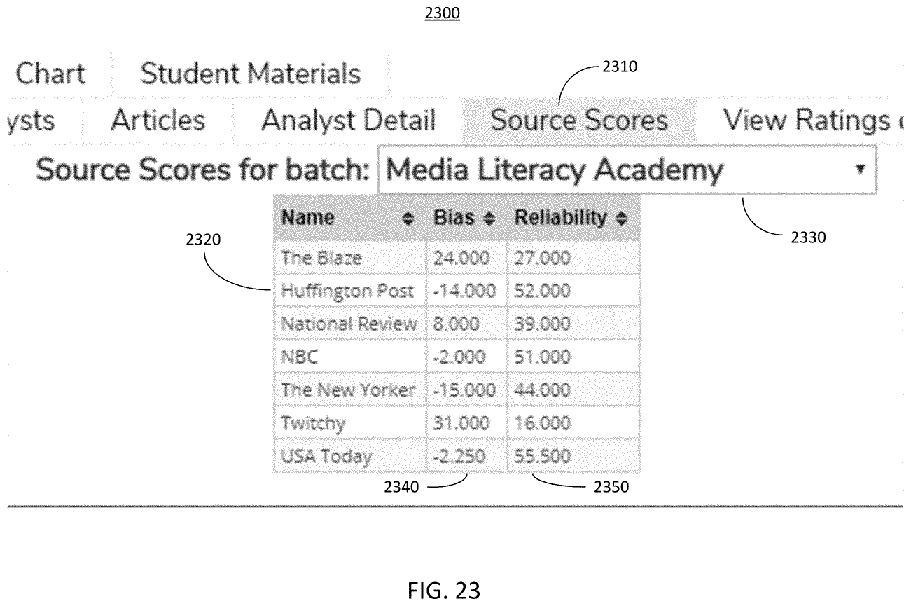

FIG. 23 shows a source score screen 2300 of the ratings interface system which may be accessed via a source scores menu tab 2310. Source scores may show in a list 2320 and display average or algorithmically weighted average scores for all individual articles (or other individual content pieces) by news source (or other information source). In the list 2320 shown, there are overall bias scores 2340 and overall reliability scores 2350. The source scores displayed are selectable according to the batch indicated in the drop-down menu. The system and administrators thereof have the ability to assign different weighting rules to different batches.

The previously described ratings interface method and system provides the benefits of helping users from students to novice news consumers to experienced and professional analysts rate overall reliability and bias of news sources. It allows them to consistently apply the same sets of definitions and standards and to consider multiple factors independently, but in an organized fashion.

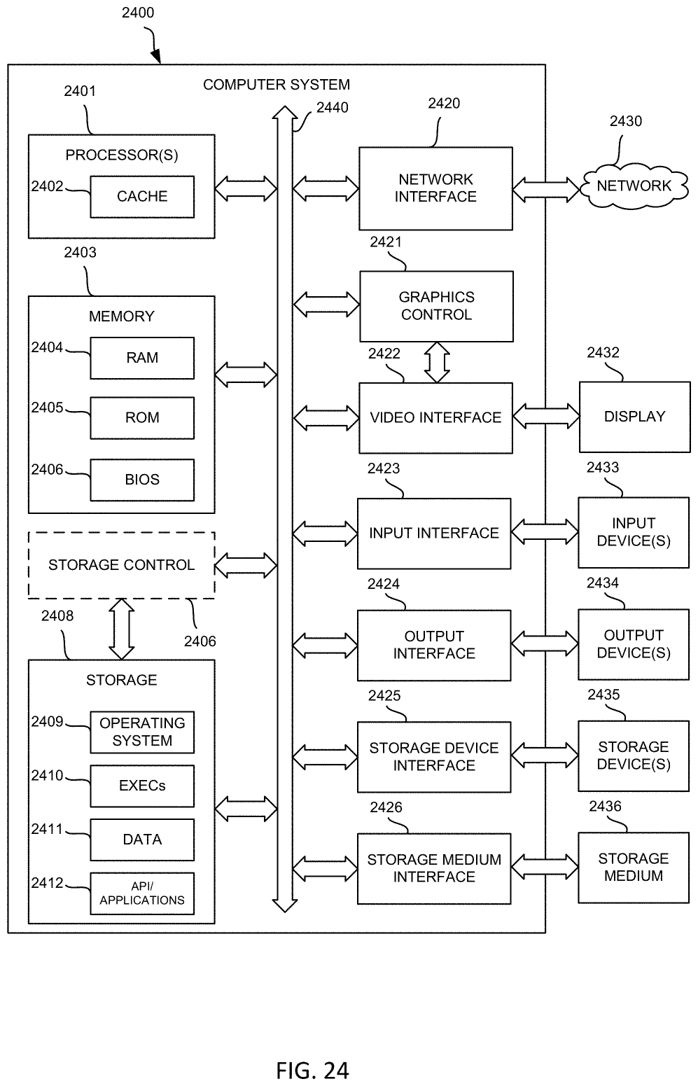

Referring now to FIG. 24, it is a block diagram depicting an exemplary machine that includes a computer system 2400 within which a set of instructions can execute for causing a device to perform or execute any one or more of the aspects and/or methodologies of the present disclosure. The components in FIG. 24 are examples only and do not limit the scope of use or functionality of any hardware, software, embedded logic component, or a combination of two or more such components implementing particular embodiments.

Computer system 2400 may include a processor 2401, a memory 2403, and a storage 2408 that communicate with each other, and with other components, via a bus 2440. The bus 2440 may also link a display 2432, one or more input devices 2433 (which may, for example, include a keypad, a keyboard, a mouse, a stylus, etc.), one or more output devices 2434, one or more storage devices 2435, and various tangible storage media 2436. All of these elements may interface directly or via one or more interfaces or adaptors to the bus 2440. For instance, the various tangible storage media 2436 can interface with the bus 2440 via storage medium interface 2426. Computer system 2400 may have any suitable physical form, including but not limited to one or more integrated circuits (ICs), printed circuit boards (PCBs), mobile handheld devices (such as mobile telephones or PDAs), laptop or notebook computers, distributed computer systems, computing grids, or servers.

Processor(s) 2401 (or central processing unit(s) (CPU(s))) optionally contains a cache memory unit 2402 for temporary local storage of instructions, data, or computer addresses. Processor(s) 2401 are configured to assist in execution of computer readable instructions. Computer system 2400 may provide functionality for the components depicted in FIG. 1 as a result of the processor(s) 2401 executing non-transitory, processor-executable instructions embodied in one or more tangible computer-readable storage media, such as memory 2403, storage 2408, storage devices 2435, and/or storage medium 2436. The computer-readable media may store software that implements particular embodiments, and processor(s) 2401 may execute the software. Memory 2403 may read the software from one or more other computer-readable media (such as mass storage device(s) 2435, 2436) or from one or more other sources through a suitable interface, such as network interface 2420. The software may cause processor(s) 2401 to carry out one or more processes or one or more steps of one or more processes described or illustrated herein. Carrying out such processes or steps may include defining data structures stored in memory 2403 and modifying the data structures as directed by the software.

The memory 2403 may include various components (e.g., machine readable media) including, but not limited to, a random-access memory component (e.g., RAM 2404) (e.g., a static RAM “SRAM”, a dynamic RAM “DRAM, etc.), a read-only component (e.g., ROM 2405), and any combinations thereof. ROM 2405 may act to communicate data and instructions unidirectionally to processor(s) 2401, and RAM 2404 may act to communicate data and instructions bidirectionally with processor(s) 2401. ROM 2405 and RAM 2404 may include any suitable tangible computer-readable media described below. In one example, a basic input/output system 2406 (BIOS), including basic routines that help to transfer information between elements within computer system 2400, such as during start-up, may be stored in the memory 2403.

Fixed storage 2408 is connected bidirectionally to processor(s) 2401, optionally through storage control unit 2407. Fixed storage 2408 provides additional data storage capacity and may also include any suitable tangible computer-readable media described herein. Storage 2408 may be used to store operating system 2409, EXECs 2410 (executables), data 2411, API applications 2412 (application programs), and the like. Often, although not always, storage 2408 is a secondary storage medium (such as a hard disk) that is slower than primary storage (e.g., memory 2403). Storage 2408 can also include an optical disk drive, a solid-state memory device (e.g., flash-based systems), or a combination of any of the above. Information in storage 2408 may, in appropriate cases, be incorporated as virtual memory in memory 2403.

In one example, storage device(s) 2435 may be removably interfaced with computer system 2400 (e.g., via an external port connector (not shown)) via a storage device interface 2425. Particularly, storage device(s) 2435 and an associated machine-readable medium may provide nonvolatile and/or volatile storage of machine-readable instructions, data structures, program modules, and/or other data for the computer system 2400. In one example, software may reside, completely or partially, within a machine-readable medium on storage device(s) 2435. In another example, software may reside, completely or partially, within processor(s) 2401.

Bus 2440 connects a wide variety of subsystems. Herein, reference to a bus may encompass one or more digital signal lines serving a common function, where appropriate. Bus 2440 may be any of several types of bus structures including, but not limited to, a memory bus, a memory controller, a peripheral bus, a local bus, and any combinations thereof, using any of a variety of bus architectures. As an example, and not by way of limitation, such architectures include an Industry Standard Architecture (ISA) bus, an Enhanced ISA (EISA) bus, a Micro Channel Architecture (MCA) bus, a Video Electronics Standards Association local bus (VLB), a Peripheral Component Interconnect (PCI) bus, a PCI-Express (PCI-X) bus, an Accelerated Graphics Port (AGP) bus, HyperTransport (HTX) bus, serial advanced technology attachment (SATA) bus, and any combinations thereof.

Computer system 2400 may also include an input device 2433. In one example, a user of computer system 2400 may enter commands and/or other information into computer system 2400 via input device(s) 2433. Examples of an input device(s) 2433 include, but are not limited to, an alpha-numeric input device (e.g., a keyboard), a pointing device (e.g., a mouse or touchpad), a touchpad, a joystick, a gamepad, an audio input device (e.g., a microphone, a voice response system, etc.), an optical scanner, a video or still image capture device (e.g., a camera), and any combinations thereof. Input device(s) 2433 may be interfaced to bus 2440 via any of a variety of input interfaces 2423 (e.g., input interface 2423) including, but not limited to, serial, parallel, game port, USB, FIREWIRE, THUNDERBOLT, or any combination of the above.

In particular embodiments, when computer system 2400 is connected to network 2430, computer system 2400 may communicate with other devices, specifically mobile devices and enterprise systems, connected to network 2430. Communications to and from computer system 2400 may be sent through network interface 2420. For example, network interface 2420 may receive incoming communications (such as requests or responses from other devices) in the form of one or more packets (such as Internet Protocol (IP) packets) from network 2430, and computer system 2400 may store the incoming communications in memory 2403 for processing. Computer system 2400 may similarly store outgoing communications (such as requests or responses to other devices) in the form of one or more packets in memory 2403 and communicated to network 2430 from network interface 2420. Processor(s) 2401 may access these communication packets stored in memory 2403 for processing.

Examples of the network interface 2420 include, but are not limited to, a network interface card, a modem, and any combination thereof. Examples of a network 2430 or network segment 2430 include, but are not limited to, a wide area network (WAN) (e.g., the Internet, an enterprise network), a local area network (LAN) (e.g., a network associated with an office, a building, a campus or other relatively small geographic space), a telephone network, a direct connection between two computing devices, and any combinations thereof. A network, such as network 2430, may employ a wired and/or a wireless mode of communication. In general, any network topology may be used.

Information and data can be displayed through a display 2432. Examples of a display 2432 include, but are not limited to, a liquid crystal display (LCD), an organic liquid crystal display (OLED), a cathode ray tube (CRT), a plasma display, and any combinations thereof. The display 2432 can interface to the processor(s) 2401, memory 2403, and fixed storage 2408, as well as other devices, such as input device(s) 2433, via the bus 2440. The display 2432 is linked to the bus 2440 via a video interface 2422, and transport of data between the display 2432 and the bus 2440 can be controlled via the graphics control 2421.

In addition to a display 2432, computer system 2400 may include one or more other peripheral output devices 2434 including, but not limited to, an audio speaker, a printer, and any combinations thereof. Such peripheral output devices may be connected to the bus 2440 via an output interface 2424. Examples of an output interface 2424 include, but are not limited to, a serial port, a parallel connection, a USB port, a FIREWIRE port, a THUNDERBOLT port, and any combinations thereof.

In addition or as an alternative, computer system 2400 may provide functionality as a result of logic hardwired or otherwise embodied in a circuit, which may operate in place of or together with software to execute one or more processes or one or more steps of one or more processes described or illustrated herein. Reference to software in this disclosure may encompass logic, and reference to logic may encompass software. Moreover, reference to a computer-readable medium may encompass a circuit (such as an IC) storing software for execution, a circuit embodying logic for execution, or both, where appropriate. The present disclosure encompasses any suitable combination of hardware, software, or both.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The various illustrative logical blocks, modules, and circuits described in connection with the embodiments disclosed herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A system for rating information source content, the system being implemented via a computer having a processor and a memory, and further comprising a graphical user interface, the interface comprising:
a graph comprising a y-axis representing information source bias and a y-axis representing information source reliability;
a plurality of graphical scoring input tools, wherein:
a first one of the plurality of graphical scoring input tools is parallel to the y-axis and has a length that corresponds to a length of the y-axis;
a second one of the plurality of graphical scoring input tools is parallel to the x-axis and has a length that corresponds to a length of the x-axis; and wherein
each of the plurality of graphical scoring input tools is configured to accept scores corresponding to values represented on at least one of the y-axis or the x-axis upon a user's interaction with one or more of the plurality of graphical scoring input tools; and
wherein the system is configured to record one or more scores assigned by the user via the user's interaction in a database associated with the interface.

2. The system of claim 1, wherein one or more of the plurality of graphical scoring interface tools comprises an interactive slider configured to be moved along a plurality of points along a length of the one or more or the plurality of graphical scoring interface tools by the user's interaction via clicking and/or dragging a mouse upon one or more portions of the graphic scoring interface tool.

3. The system of claim 1, wherein one or more of the plurality of graphical scoring interface tools displays numerical scores corresponding to the values represented on at least one of the y-axis or the x-axis.

4. The system of claim 1, wherein the plurality of graphical scoring input tools comprises:
a plurality of vertical graphical scoring input tools each parallel with the y-axis and each other,
and a plurality of horizontal graphical scoring input tools each parallel with the x-axis and each other, and
wherein a first one of the plurality of vertical graphical scoring input tools represents an overall score for information source reliability and one or more others of the plurality of vertical graphical scoring input tools represents one or more sub-factors for rating information source reliability, and
a first one of the plurality of horizontal graphical scoring input tools represents an overall score for information source bias and one or more others of the plurality of horizontal graphical scoring input tools represents one or more sub-factors for rating information source bias.

5. The system of claim 4, wherein the one or more sub-factors for rating information source reliability are one or more of:
veracity;
expression; and
headline.

6. The system of claim 4, wherein the one or more sub-factors for rating information source bias are one or more of:
political position;
language; and
comparison.

7. The system of claim 1, wherein the interface further comprises:
an input field configured to accept identifying information for a piece of information source content; and
a display field configured to display one or more of:
the identifying information, and
the piece of information source content to a user.

8. The system of claim 7, wherein the identifying information for a piece of information source content is a website URL.

9. The system of claim 7, wherein the identifying information for a piece of information source content comprises a name, date, and time of a television show.

10. The system of claim 1, wherein the interface further comprises a second graph comprising a y-axis representing information source bias and a y-axis representing information source reliability, wherein the second graph is configured to display the one or more scores assigned by the user and recorded in the database.

11. The system of claim 10, wherein the second graph is configured to display a logo representing the information source content on a location on the second graph corresponding to the one or more scores.

12. The system of claim 1, wherein the interface further comprises:
one or more input fields configured to accept identifying information for one or more analysts, and
wherein the interface is configured to assign one or more pieces of information source content to the one or more analysts for scoring.

13. The system of claim 1, wherein the interface is configured to present a list of information source content from which an user may select a particular piece of information source content to rate.

14. The system of claim 1, wherein the information source is at least one of:
an online news article;
a television show;
a podcast;
a radio show; and
a social media post.

15. The system of claim 1, wherein the system is further configured to:
record a plurality of scores for a plurality of pieces of information source content from a particular information source;
average the plurality of scores to create an average score for the particular information source; and
display the average score on a second graph of the interface.

16. The system of claim 1, wherein the system is further configured to:
record a plurality of scores for a plurality of pieces of information source content from a particular information source;
calculate an algorithmically weighted average of the plurality of scores based on rules assigning higher weights to particular scores to create a weighted average score for the particular information source; and
display the weighted average score on a second graph of the interface.

17. The system of claim 4, wherein the one or more sub-factors for rating information source reliability are one or more of:
importance;
reporting effort;
fairness;
headline;
graphic;
lede;
guests;
quotes;
humor; and
other.
